(19) United States
(12) Patent Application Publication
(10) Pub. No.: US 2017/0218947 A1
(43) Pub. Date: Aug. 3, 2017

(54) IRONHORSE CONTROLLER WITH AUTOMATIC PUMP OFF CONTROL

(71) Applicant: SPOC AUTOMATION, Trussville, AL (US)

(72) Inventors: Stacey Mark BROOKS, Sardis City, AL (US); Michael Dean ISRAEL, Tulsa, OK (US)

(73) Assignee: SPOC AUTOMATION, Trussville, AL (US)

(21) Appl. No.: 15/417,936

(22) Filed: Jan. 27, 2017

Related U.S. Application Data
(60) Provisional application No. 62/287,986, filed on Jan. 28, 2016.

(51) Int. Cl. F04B 49/10; H02P 1/02; F04B 49/06

(52) U.S. Cl. CPC F04B 49/103; F04B 49/065; H02P 1/029

(57) ABSTRACT

An apparatus, method, and non-transitory computer readable recording medium to control a pump system may include a memory storing instructions and a processor that executes the instructions to obtain initial motor data of a motor controlled by a variable frequency drive (VFD) and determine a normal speed baseline of the motor based on the obtained initial motor data. The processor may also obtain current motor data of the motor, detect a pump-off event of the pump system when the current motor data deviates from the normal speed baseline, and control the VFD in response to the detected pump off event.

### CROSS-REFERENCE TO RELATED APPLICATIONS

This application claims the benefit of U.S. Provisional Patent Application No. 62/287,986, filed on Jan. 28, 2016, in the U.S. Patent and Trademark Office, the disclosure of which is incorporated herein in its entirety by reference.

### BACKGROUND OF THE INVENTION

1. Field of the Invention

The present disclose uses methods for controlling a fluid, for example oil, pumping system, and apparatuses and systems for performing the methods.

2. Description of the Related Art

At present, most current pumping systems on the market require at least two sensors to detect a well pump-off. A well pump-off is when the fluid removed by the pump is greater than the inflow of the fluid from the formation into the pump.

The two sensors usually required are a position sensor and a load cell. The position sensor detects the rod pump position and the load cell detects how much fluid is being removed from the well. Based on the position data and load cell, adjustments may be made. If the current pumping system has a variable frequency drive, the motor speed can be adjusted. If the current pumping system only has a traditional motor starter, the only options are to run or stop the motor.

### SUMMARY OF THE INVENTION

An apparatus, method, and non-transitory computer readable recording medium to control a pump system may include a memory storing instructions and a processor that executes the instructions to obtain initial motor data of a motor controlled by a variable frequency drive (VFD), determine a normal speed baseline of the motor based on the obtained initial motor data, obtain current motor data of the motor, detect a pump-off event of the pump system when the current motor data deviates from the normal speed baseline, and control the VFD in response to the detected pump off event.

Additional aspects will be set forth in part in the description which follows and, in part, will be apparent from the description, or may be learned by practice of the presented exemplary embodiments.

### BRIEF DESCRIPTION OF THE DRAWINGS

These and/or other aspects will become apparent and more readily appreciated from the following description of the exemplary embodiments, taken in conjunction with the accompanying drawings in which:

FIGS. 1A and 1B are block diagrams of a pumping system and a controller of the pump system, according to an exemplary embodiment;

FIGS. 2A and 2B are flowcharts for explaining a method of controlling a pump system, according to an exemplary embodiment;

FIGS. 3A, 3B, and 3C are flowcharts for explaining several methods of SPM calibration, according to exemplary embodiments;

FIGS. 4A and 4B are flowcharts for explaining several methods of determining a minimum speed baseline, according to an exemplary embodiment;

FIGS. 5A and 5B are flowcharts for explaining several methods of determining a normal speed baseline, according to an exemplary embodiment;

FIGS. 6A and 6B are flowcharts for explaining several methods of detecting a pump-off event, according to an exemplary embodiment;

FIGS. 7A and 7B are flowcharts for explaining several methods of determining a rolling average of an average motor torque, according to an exemplary embodiment;

FIGS. 8A and 8B are flowcharts for explaining several methods of detecting deviation, according to an exemplary embodiment;

FIGS. 9A, 9B, 9C, 9D, 9E, 9F, 9G, and 9H are views for explaining a method of SPM calibration, according to an exemplary embodiment;

FIGS. 10A and 10B are views for explaining a method of reducing the amount of regenerated DC bus voltage, according to an exemplary embodiment; FIG. 10C is a flowchart for explaining a method of reducing the amount of regenerated DC bus voltage, according to the exemplary embodiment disclosed in FIGS. 10A and 10B;

FIGS. 11A, 11B, 11C, 11D, 11E, 11F, 11G, and 11H are views for explaining a method of controlling a pumping system, according to an exemplary embodiment;

FIGS. 12A, 12B, 12C and 12D are flowcharts for explaining a method of controlling a pumping system, according to an exemplary embodiment;

FIG. 13A is a view for explaining a method of leak detection, pump wear, and waxing detection; FIGS. 13B and 13C are flowcharts for explaining a method of leak detection, pump wear, and waxing detection; and

FIG. 14 is a flowchart for explaining a method of controlling a pumping system, according to an exemplary embodiment.

### DETAILED DESCRIPTION

Reference will now be made in detail to embodiments, examples of which are illustrated in the accompanying drawings. In this regard, the embodiments may have different forms and should not be construed as being limited to the descriptions set forth herein. In order to further clearly describe features of the embodiments, descriptions of other features that are well known to one of ordinary skill in the art are omitted here.

The singular forms “a,” “an” and “the” are intended to include the plural forms as well, unless the context clearly indicates otherwise. The term of “and/or” includes a plurality of combinations of relevant items or any one item among a plurality of relevant items. The term “at least” preceding a listing of items denotes one or any combination of the items in the listing. The terms “comprise(ing),” “include(ing),” and “have(ing)” when used in this specification, specify the presence of stated features, functions, processes/operations, elements, and/or components, but do not preclude the presence or addition of one or more other features, functions, processes/operations, elements, components, and/or groups thereof.

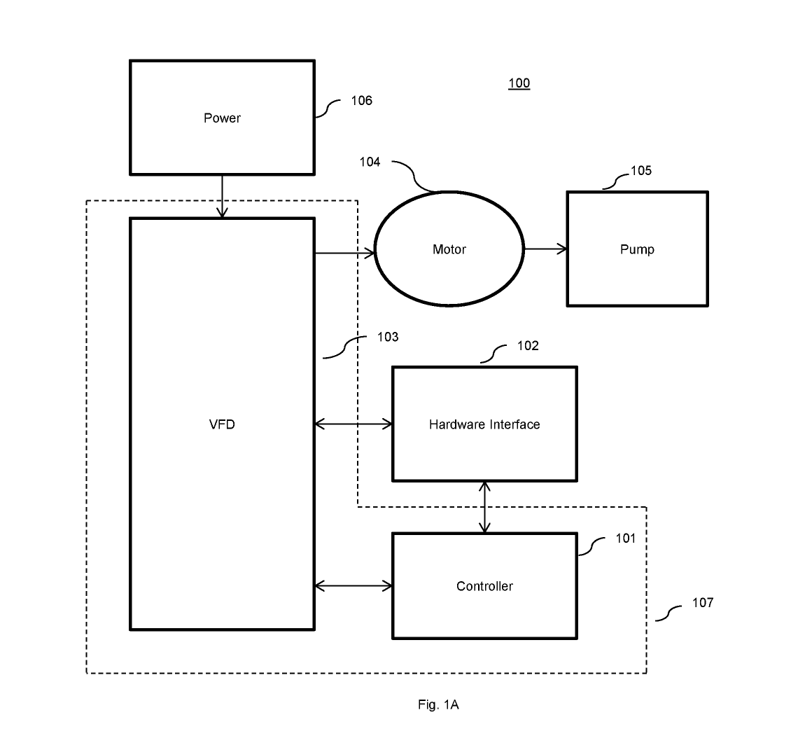

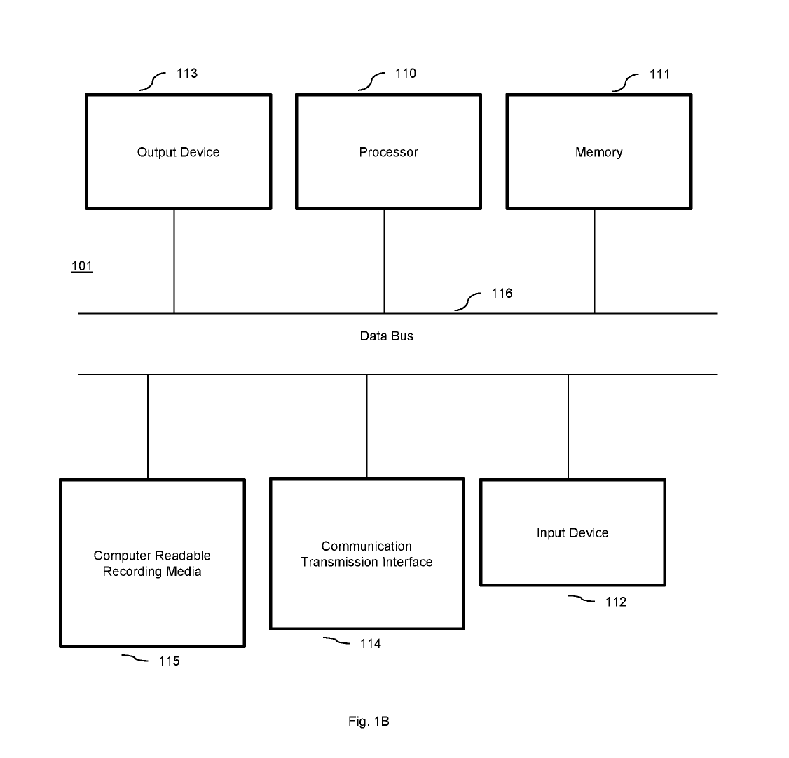

FIGS. 1A and 1B are block diagrams of a pumping system and a controller of the pump system, according to an exemplary embodiment. Referring to FIG. 1A, the pumping system 100 may include a pumping control system 107 that includes a controller 101 and a variable frequency drive (VFD) 103. The pumping system 100 may also include a hardware interface 102, a motor 104 and a pump 105, and the pumping system 100 may receive power from a power source 106.

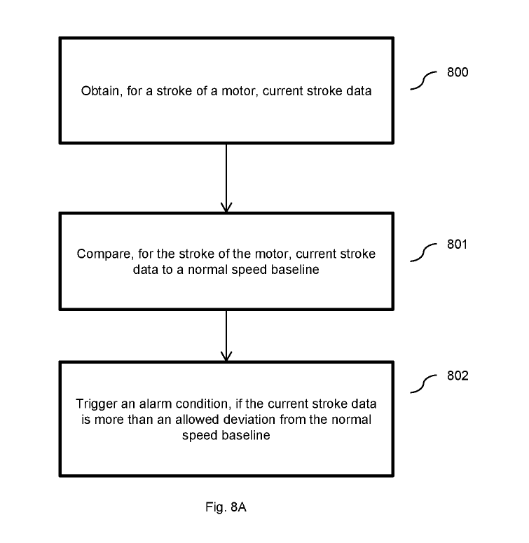

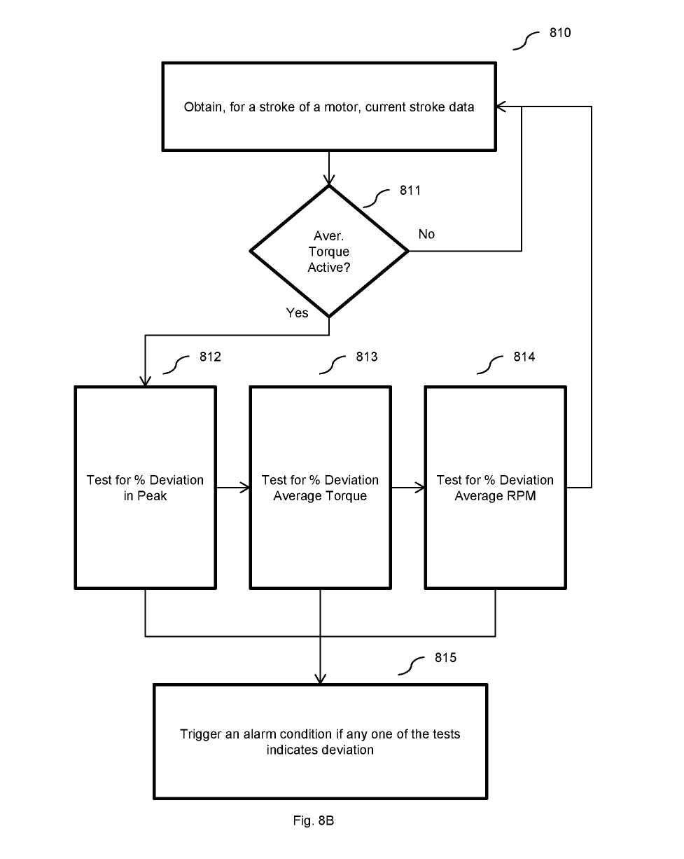

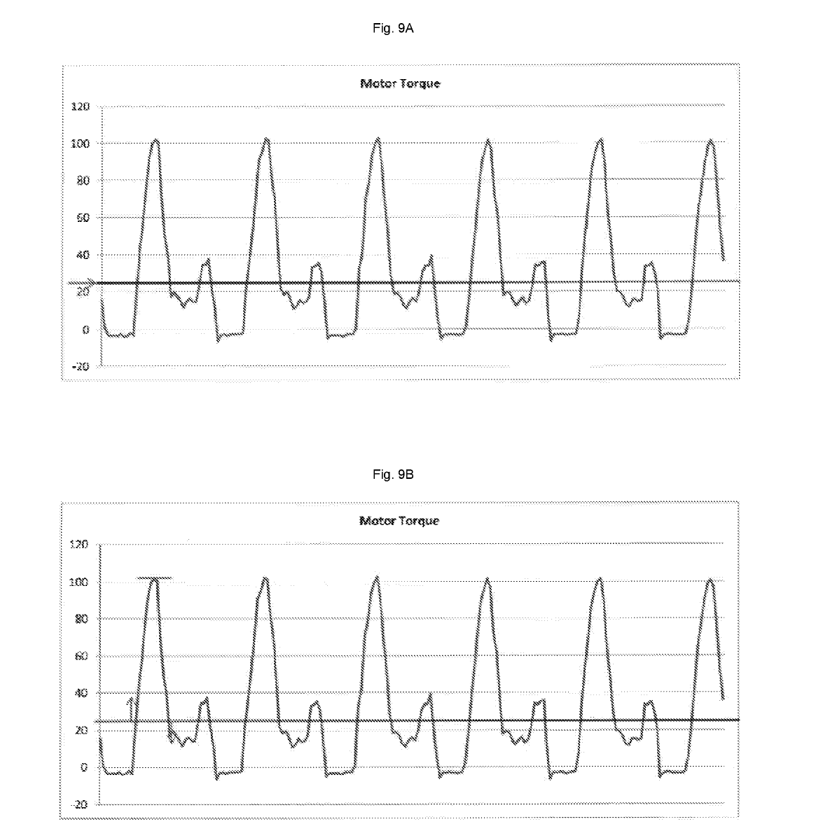

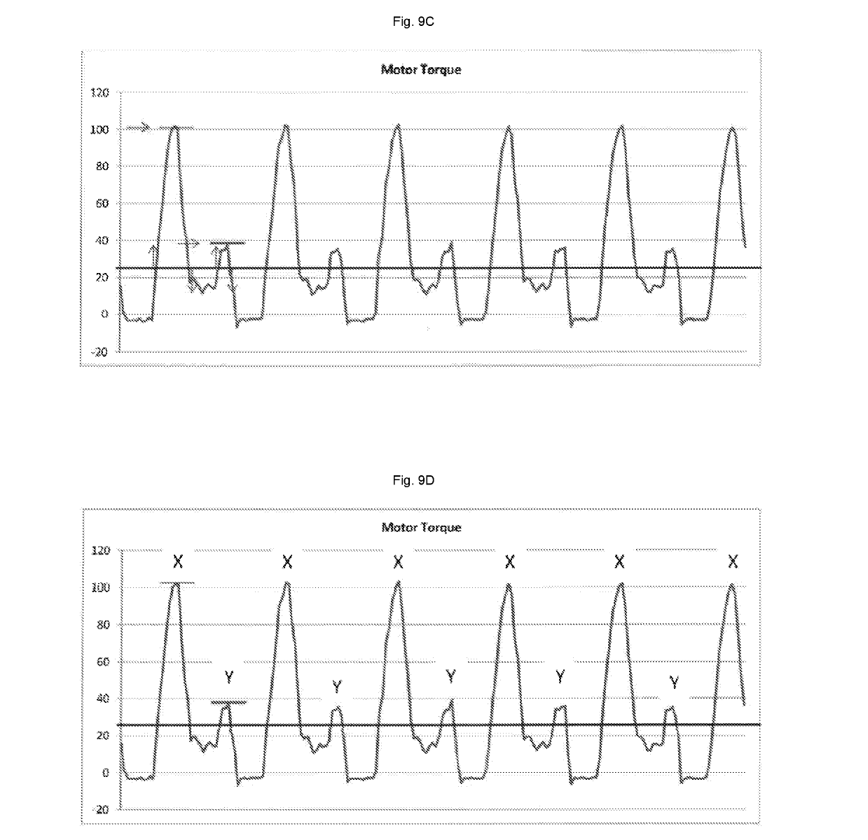

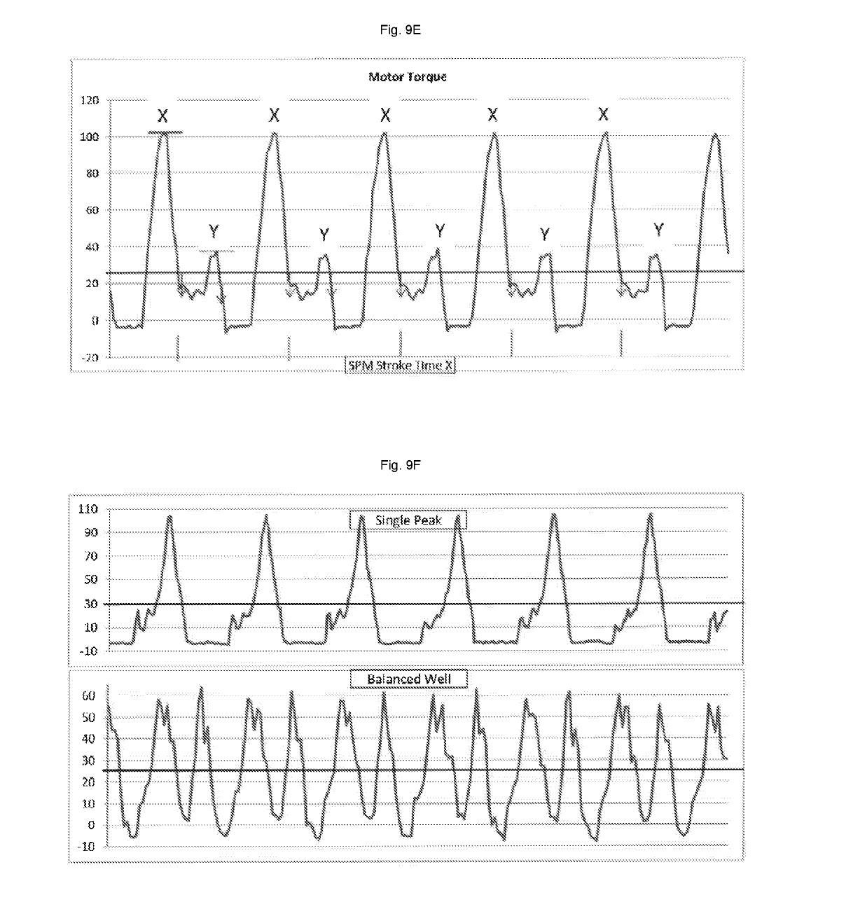

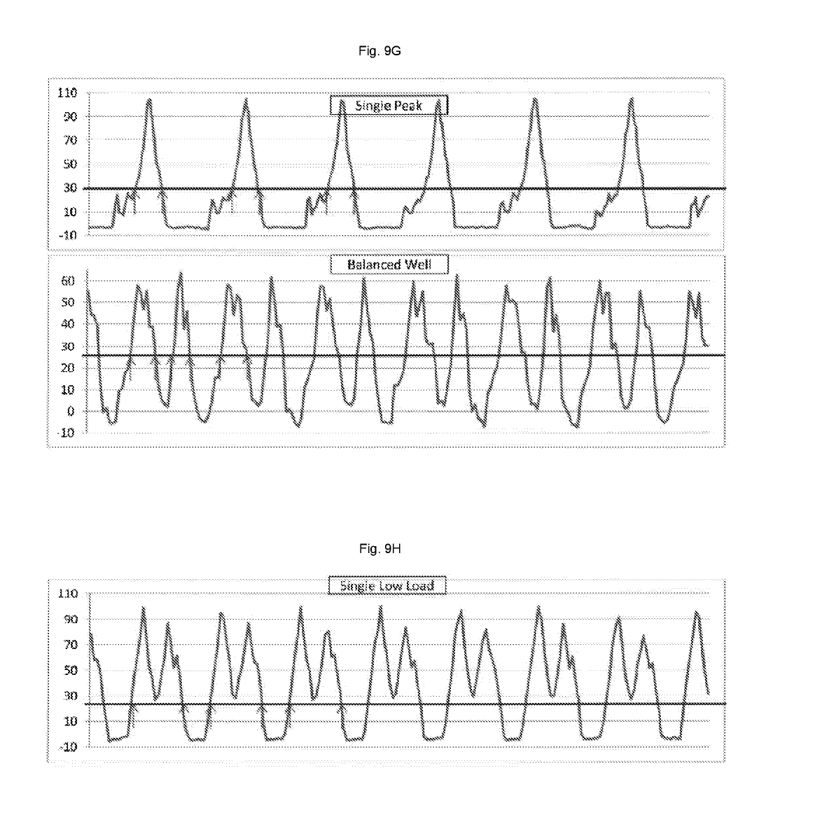

The VFD 103 may be controlled by the controller 101. The VFD 103 may be supplied with electric power by the power source 106 and the VFD 103 may provide the ability to run the motor 104 at different speeds, as instructed by the controller 101. The VFD 103 may transmit motor data of the motor 105 to the controller 101. Motor data may include the voltage and current draw of the motor 105, the instantaneous torque load on the motor 105, the motor speed and rotations per minute of the motor 105. The VFD 103 may transmit a sufficient number of motor data samples per second to ensure the controller 101 has a proper resolution of a torque profile of the motor 105. A torque profile may be a sinusoidal cycle of instantaneous torque load as a function of time. A higher number of motor data samples per second may result in redundant observations and a smaller number of data samples per second may result in too much variation. Generally, the resolution required is based on the frequency and amplitude of the stroke of the pumping system 100. For example, FIGS. 9A-9H are examples of instantaneous motor torque as a function of time, which can illustrate visually the amplitude and frequency of the stroke of the pumping system 100. For example, the VFD 103 may transmit about 5 samples of motor data per second.

The VFD 103 may calculate the instantaneous torque load of the motor data based on the voltage and current drawn by the motor 104. The VFD 103 may calculate the instantaneous torque load as a torque percentage based on the motor nameplate data which describes the operational capabilities of the motor. For example, the motor nameplate data may include the motor's ideal full load rating in horsepower, voltage, current, and rotations per minute (RPM). The VFD 103 may obtain the nameplate data of the motor 105 by various means. For example, the VFD 103 may receive the nameplate data from the motor 105 or the controller 101; the nameplate data may be entered into controller 101 by a user or retrieved from the internet, during installation of the pumping control system 107; the nameplate data may be entered into the VFD 103 when the VFD 103 is installed.

For instance, with a three-phase AC voltage, the VFD 103 may calculate the horse power (HP) of the motor 104 by Equation 1. In Equation 1, volts and amps are the voltage and current draw of the motor 105. The (1.73) is a scalar is to represent the square root of (3) for the three-phase AC case. One of skill in the art could determine the proper scalar for a non-three-phase AC case. Combined, (1.73) (volts) (amps) represents the watts of the motor 104. One of skill in the art could determine the watts of the motor 104 in another way. The (746) is a unit conversion from watts to HP.

$$H P = \frac{( 1.73 ) ( volts ) ( amps )}{( 746 )} \qquad Equation 1$$

Further, the VFD 103 may calculate the torque by Equation 2, for both (a) the nameplate data and (b) the instantaneous torque. In Equation 2(a), Trqₙₐₘₑₚₗₐₜₑ is the full load torque rating of the motor 104; HPₙₐₘₑₚₗₐₜₑ is the full load horsepower rating of the motor 104; and RPMₙₐₘₑₚₗₐₜₑ is the full load RPM rating of the motor 104. In Equation 2(b), Trqₗᵢᵥₑ is the torque load of the motor 104; HPₗᵢᵥₑ is the current horsepower load of the motor 104, for example as calculated from equation 1; and RPMₗᵢᵥₑ is the current RPM of the motor 104.

$$\begin{matrix}{Trq}_{nameplate} = \frac{{HP}_{nameplate}}{{RPM}_{nameplate}} & Equation 2 ( a ) \\ {Trq}_{live} = \frac{{HP}_{live}}{{RPM}_{live}} & Equation 2 ( b )\end{matrix}$$

Lastly, the VFD 103 may calculate the torque percentage by Equation 3. In Equation 3, Trq % is the torque percentage; Trq is the torque load of the motor 104 as calculated above; and Trqₙₐₘₑₚₗₐₜₑ is the full load torque rating of the motor 104 as calculated.

$$Trq \% = \frac{{Trq}_{live}}{{Trq}_{nameplate}} \qquad Equation 3$$

The motor 104 may drive the pump 105 based on the electric power provided by the VFD 103. The pump 105 may artificially lift a fluid to be extracted to a surface. Those skilled in the art would recognize that there are many different combinations that could make up the pump, for example a rod pump. The hardware interface 102 may allow a connection and control over various field devices, such as switches. The hardware interface 102 may be connected to either or both of the VFD 103 and the controller 101.

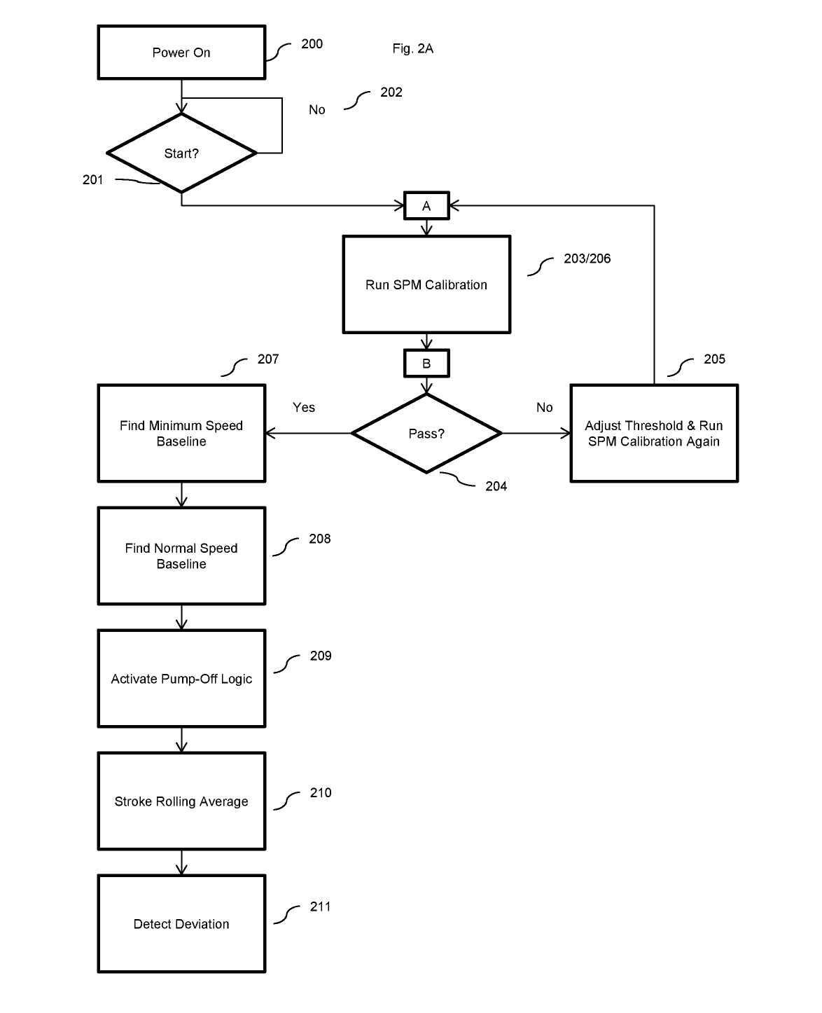

The controller 101 may receive the motor data from the VFD 103. The controller 101 controls the operations of the pumping system 100 according to one or more of the embodiments in FIGS. 2-14, as described below.

Referring to FIG. 1B, the controller 101 may be implemented as an apparatus (a machine) that includes processing hardware configured, for example, by way of software executed by the processing hardware and/or by hardware logic circuitry, to perform the described features, functions, operations, and/or benefits. A computing apparatus, such as (in a non-limiting example) any computer or computer processor that includes processing hardware and can store, receive, retrieve, process and/or output data and/or communicate (network) with other computing apparatuses. According to an aspect of an embodiment, the described features, functions, operations, and/or benefits can be implemented by and/or use processing hardware and/or software executed by processing hardware.

For example, the controller 101, as illustrated in FIG. 1B, may include a processor 110, a memory 111, an input device 112, an output device 113, a communication transmission interface 114, a computer readable recording media 115, and a data bus 116.

The processor 110 may be a central processing unit (CPU) or computing processing system (e.g., one or more processing devices (e.g., chipset(s), including memory, etc.) that processes or executes instructions, namely software/program, stored in the memory 111.

The controller 101 may use the memory 111 to store software and the processor 110 may execute the software to control the variable frequency drive 103. The controller 101 may also store data in the memory 111. The memory 111 may be a computer-readable media, e.g., a non-transitory or persistent computer-readable medium. Examples of the non-transitory computer-readable media include a magnetic recording apparatus, an optical disk, a magneto-optical disk, and/or volatile and/or non-volatile semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), DVD-ROM, DVD-RAM (DVD-Random Access Memory), BD (Blue-ray Disk), a CD-ROM (Compact Disc-Read Only Memory), and a CD-R (Recordable)/RW.

The input device 112 allows a user to input data or indicate settings for the controller 101. The input device 112 may be, for example, a set of buttons or a touch sensor. The output device 113 may be a display screen, e.g., Cathode ray tube display (CRT), Light-emitting diode display (LED) Electroluminescent display (ELD), Electronic paper, E Ink, Plasma display panel (PDP), Liquid crystal display (LCD), or Organic light-emitting diode display (OLED). Additionally, the input device 112 may be combined with the output device 113 in the form of a touch screen, or a combination of the above features.

The communication transmission interface 114 may be for communicating with another device and the communication transmission interface 114 may support various communication methods. For example, the communication transmission interface 114 may be a wired or wireless interface for a user's device to connect to the controller 101. For example, the communication transmission interface 114 may use a standard such as Wi-Fi, NFC, or Bluetooth for wireless and Ethernet for wired. Specifically, the communication transmission interface 114 may communicate with the VFD 103 to transmit to and receive communication signals from the VFD 103. More specifically, the communication transmission interface 114 may use a wired Ethernet connection using the TCP/IP ver. 4 or TCP/IP ver. 6 to communicate with the VFD 103. Alternatively or additionally, the communication transmission interface 114 may allow a user to connect a device to the controller 101 to thereby input data, collect data, or indicate settings for the controller 101.

The data bus 116 connects all the internal components of the controller 101 and allows communication amongst them according to known standards. For example, the data bus 116 may make use of a standard such as I²C or PCI Express (PCIe), or Serial ATA (SATA).

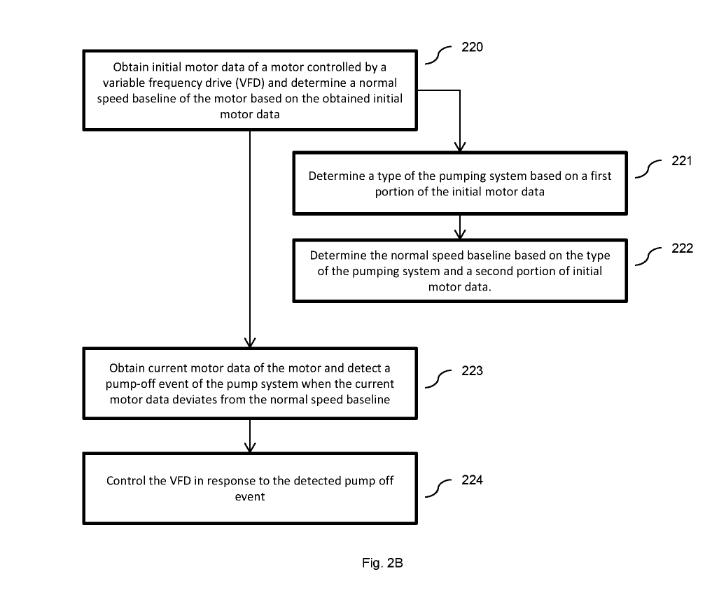

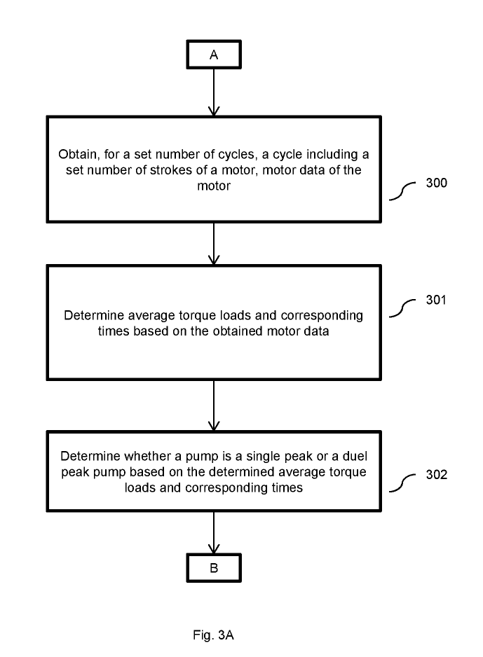

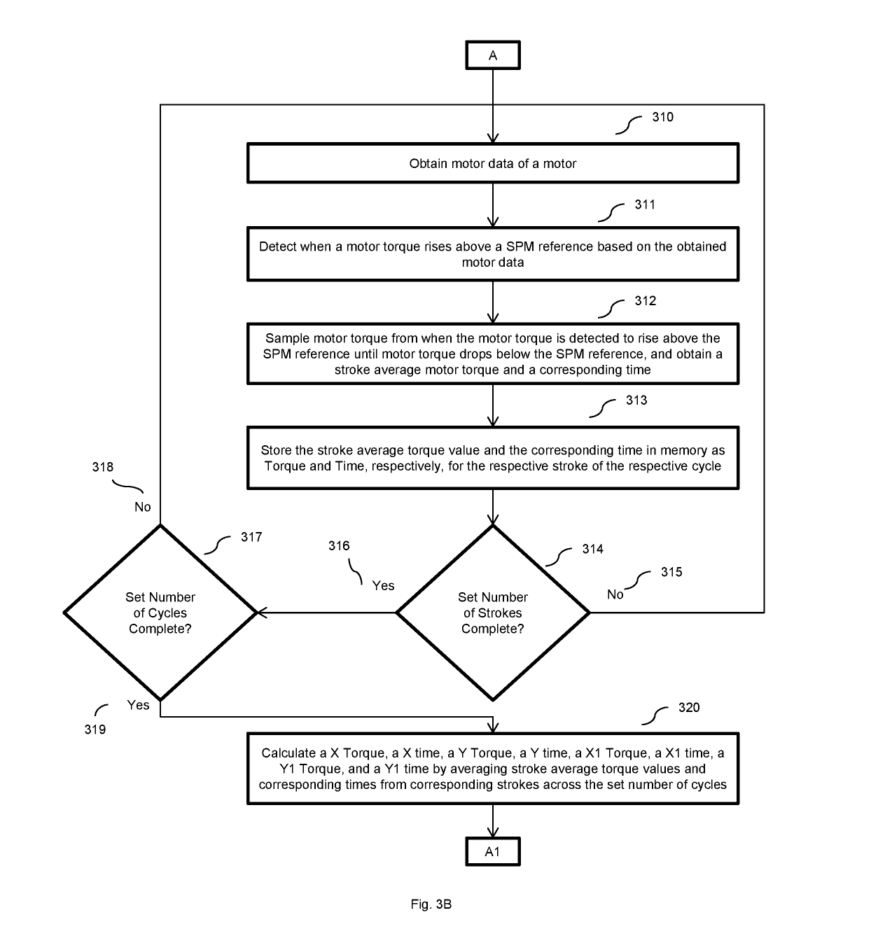

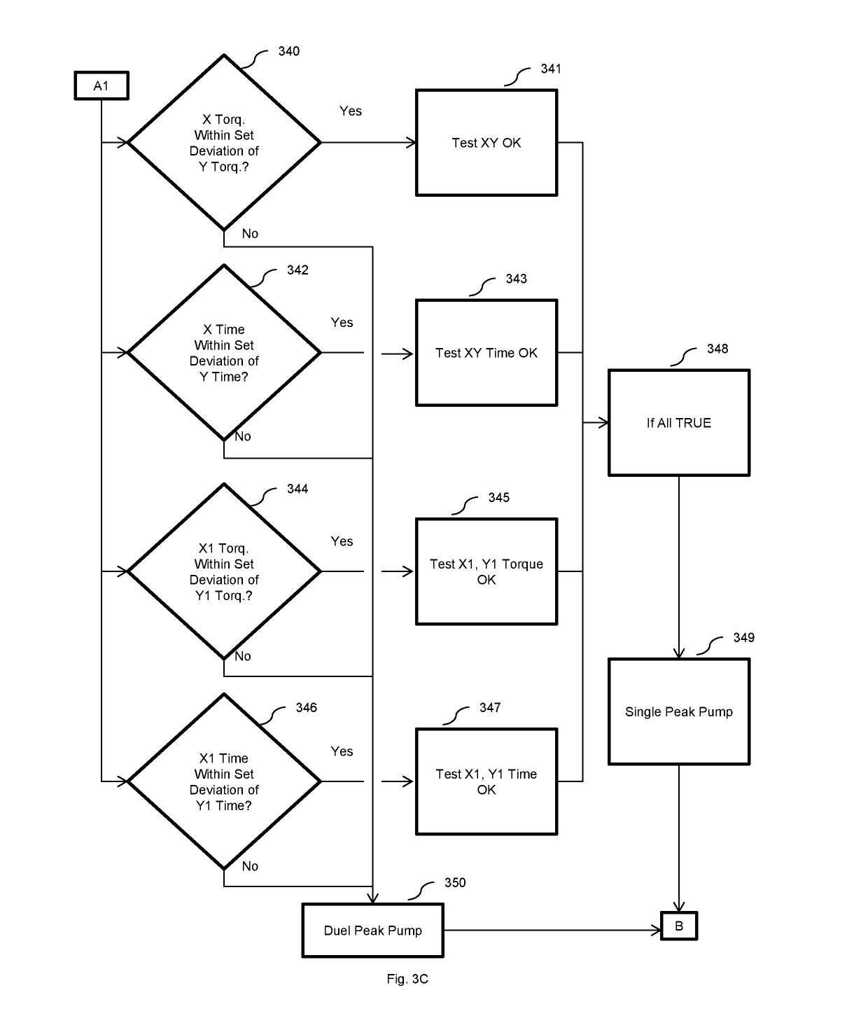

FIGS. 2A and 2B are flowcharts for explaining a method of controlling a pump system, according to an exemplary embodiment. Referring to FIG. 2A, the pumping system 100 is powered on (200). After power is applied, the controller 101 may wait for a start command from a user via input device 112 to begin control of pumping system 100 (201). If no start command is received, the controller 101 may continue waiting (202). If the pumping system 100 receives a start command, the controller 101 may continue to a stroke per minute (SPM) calibration routine (203), which is described in further detail below in FIGS. 3A, 3B, and 3C.

The controller 101 may determine if the SPM calibration passes or fails (204). If the SPC calibration routine fails at a set SPM reference threshold, then the controller 101 may adjust the SPM reference threshold (205) and run the SPM calibration routine again with a SPM reference new threshold (206). If the SPM calibration routine passes at the set SPM reference threshold, then the controller 101 may continue to find minimum speed baseline routine (207), which is described in further detail below in FIGS. 4A and 4B.

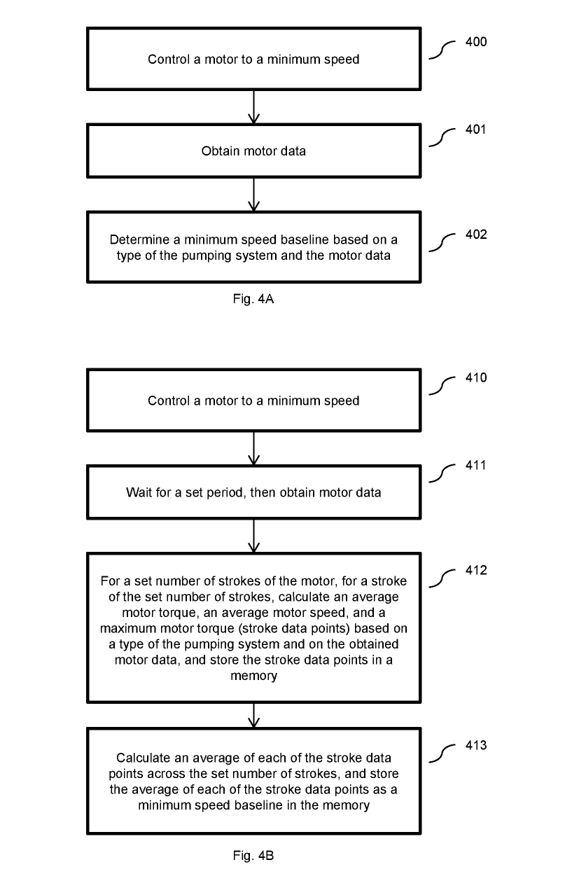

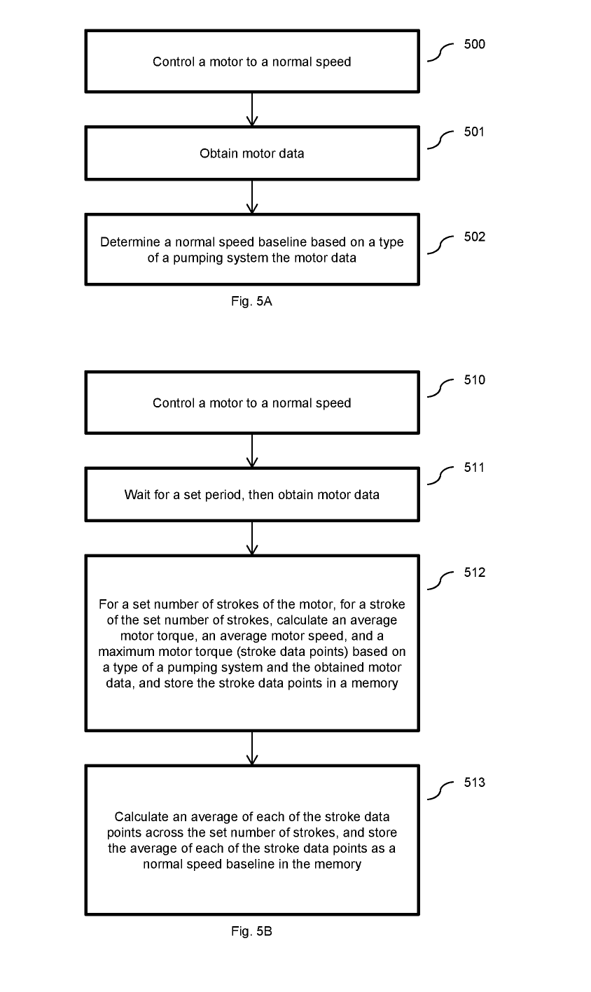

The controller 101 may then continue to the find normal speed baseline routine (208), which is described in further detail below in FIGS. 5A and 5B.

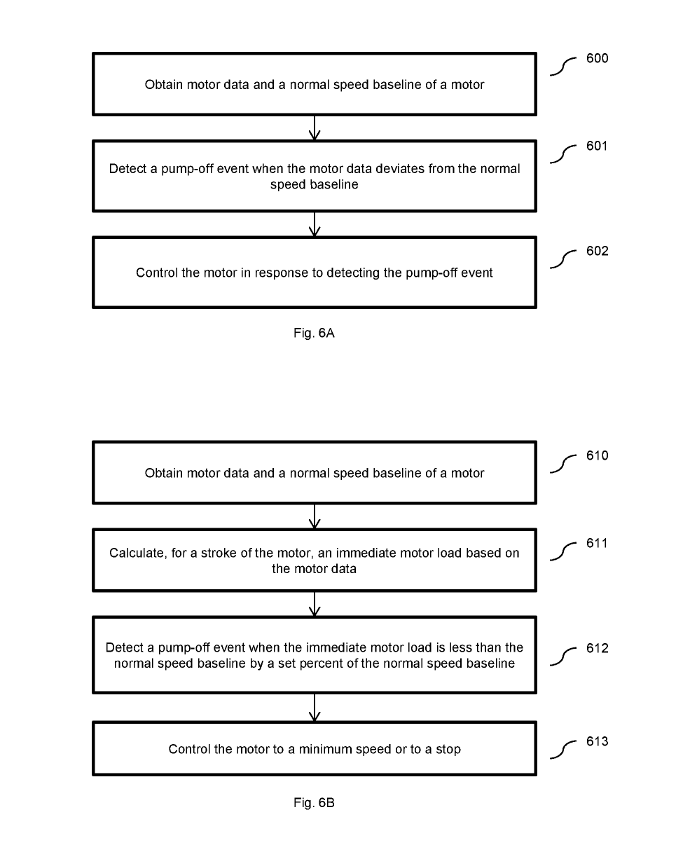

The controller 101 may then turn the pump-off detection routine to the ON state (209) from the default OFF state. The pump-off detection routine is described in further detail below in FIGS. 6A and 6B.

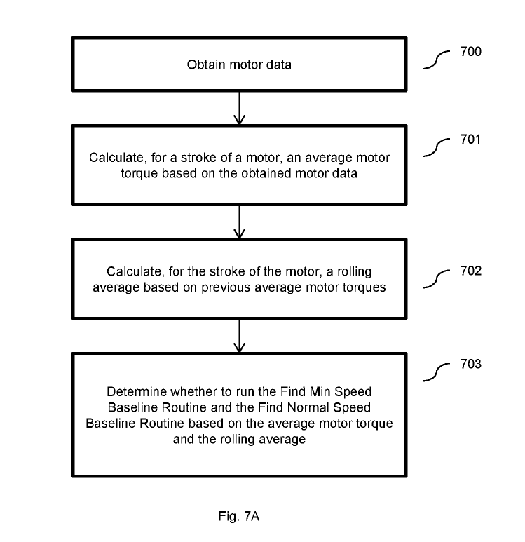

The controller 101 may then continue to stroke rolling average routine (210), which is described in further detail below in FIGS. 7A and 7B, and 3C.

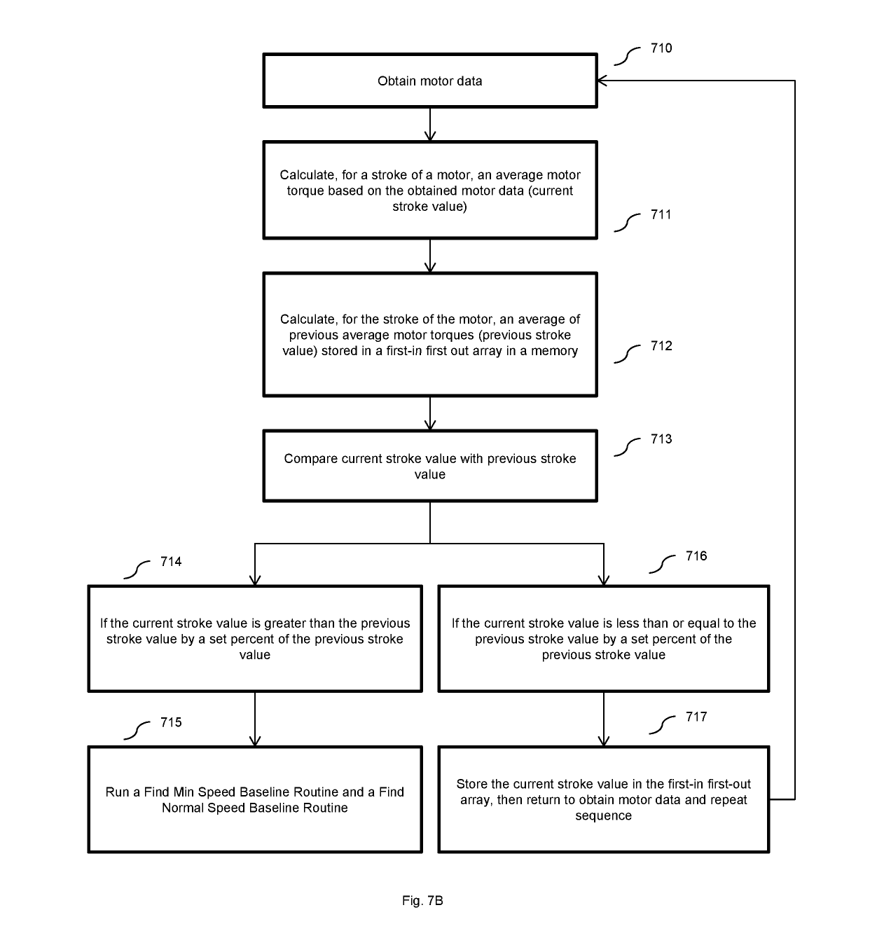

The controller 101 may then continue to deviation testing routine (211), which is described in further detail below in FIGS. 8A and 8B.

Referring to FIG. 2B, the controller 101 may obtain initial motor data of a motor controlled by a variable frequency drive (VFD) and determine a normal speed baseline of the motor based on the obtained initial motor data (220). The controller 101 may obtain current motor data of the motor and detect a pump-off event of the pump system when the current motor data deviates from the normal speed baseline (223). The controller 101 may control the VFD in response to the detected pump off event (224).

To determine the normal speed baseline of the motor, the controller 101 may determine a type of the pumping system based on a first portion of the initial motor data (221) and determine the normal speed baseline based on the type of the pumping system and a second portion of initial motor data (222).

More specifically, the initial motor data is motor data transmitted by the VFD 103 to the controller 101 after the pumping system 100 is turned on and the initial motor data may include a first portion and a second portion. The first portion of the initial motor data is motor data for a set of cycles, each cycle including a set number of strokes of the motor 105, used to determine the type of the pumping system 100. The second portion of the initial motor data is motor data for a set of cycles, each cycle including a set number of strokes of the motor 105, used to determine a normal speed baseline. A stroke of a motor may be the time period between when an instantaneous motor torque drops below a SPM torque reference until the instantaneous motor torque drops below the SPM torque reference again, which is informed by the type of the pump system (e.g., single peak or dual peak system). The current motor data is motor data transmitted by the VFD 103 to the controller 101 after the normal speed baseline is determined. For both the initial motor data and the current motor data, the controller 101 may receive from the VFD 103 a set number of motor data samples per second. For instance, 5 samples per second.

FIGS. 3A, 3B, and 3C are flowcharts for explaining several methods of SPM calibration, according to exemplary embodiments. Referring to FIG. 2A, if the pumping system 100 receives a start command, the controller 101 may continue to a stroke per minute (SPM) calibration routine (203), which may identify the pumping system as one of two types. The pumping system 100 type may also be a stored parameter in memory 111. For example, if the pumping system 100 has not been turned off for longer than 5 minute and a type has been stored in memory 111, the SPM calibration may be omitted. The two types may be single peak or dual peak. If the SPM calibration routine passes at a set SPM reference threshold, then the controller 101 may continue to find minimum speed baseline routine (207). The SPM reference threshold is set so that at least one crossing of instantaneous torque and the SPM reference threshold may occur. By default, the SPM reference threshold is 15% of full motor torque load. If the SPC calibration routine fails at the set SPM reference threshold, then the controller 101 may adjust the SPM reference threshold (205) and run SPM calibration routine again with a new SPM reference threshold (206). The controller 101 may attempt to run the SPM calibration routine a set number of times until a pass is achieved, then, if no pass is achieved the controller 101 may activate an alarm. For example, the controller 101 may attempt to pass the SPM calibration two times, and then activate an alarm if a pass is not achieved.

Referring to FIG. 3A, the controller 101 may obtain, for a set number of cycles, a cycle including a set number of strokes of a motor, motor data of the motor (300). The controller 101 may then determine average torque loads and corresponding times based on the obtained motor data (301). The controller 101 may then determine whether a pump is a single peak or a duel peak pump based on the determined average torque loads and corresponding times (302). A “corresponding time” may be the time from when an instantaneous motor torque drops below a SPM torque reference to when the instantaneous motor torque drops below the SPM torque reference again, for a stroke of the motor that has a determined average torque load. One of skill in the art could choose other cyclic references to arrive at the corresponding time for a stroke of the motor, e.g., time between local maximum of the instantaneous motor torque.

In another embodiment, the controller 101 may obtain, for a set number of cycles, each cycle including a set number of strokes of a motor 104, motor data of the motor 104. The controller 101 may then determine average torque loads and corresponding times for each stroke based on the obtained motor data. The controller 101 may then determine whether a pump is a single peak or a duel peak pump based on the determined average torque loads and corresponding times.

Referring to FIGS. 3B and 3C, FIGS. 3B and 3C are more specific methods of FIG. 3A, where FIG. 3C is a continuation of FIG. 3B. Referring to FIG. 3B, the controller 101 may start at A, then the controller 101 may obtain motor data of a motor (310). The controller 101 may then detect when a motor torque rises above a SPM reference based on the obtained motor data (311). The controller 101 may then sample motor torque from when the motor torque is detected to rise above the SPM reference until motor torque drops below the SPM reference, and obtain a stroke average motor torque and a corresponding time (312). The controller 101 may then store the stroke average torque value and the corresponding time in memory as Torque and Time, respectively, for the respective stroke of the respective cycle (313). The controller 101 may then determine whether a set number of strokes have been completed (314). If the controller 101 determines that the set number of strokes have not been completed (315), then the controller 101 may return to obtain motor data again. If the controller determines that the set number of strokes have been completed (316), then the controller 101 may continue to determine if the set number of cycles have been completed (317). If the controller determines that the set number of cycles have not been completed (318), the controller may continue to obtain motor data again. If the controller 101 determines that the set number of cycles have been completed (319), the controller 101 may calculate a X Torque, a X time, a Y Torque, a Y time, a X1 Torque, a X1 time, a Y1 Torque, and a Y1 time by averaging stroke average torque values and corresponding times from corresponding strokes across the set number of cycles (320). Then, the controller 101 may continue to A1.

More specifically, the controller 101 may run a torque sampling routine. The torque sampling routine can be run a set number of times. For example, the torque sampling routine may be repeated for five cycles. Each of the cycles may consist of 4 sub-routines: first sub-routine, second sub-routine, third sub-routine, and fourth sub-routine. Each of the cycles may be stored in a data structure in the memory 111 to be used at the end of the process. For example, the data structure may be an array to be used at the end of the process.

In the first sub-routine, the controller 101 may detect when a motor torque rises above a SPM torque reference, which is a set threshold. Then, the controller 101 may start sampling motor torque values and averages of the motor torque for a set period. The controller 101 may use a timer to keep track of the set period. When the motor torque drops below the SPM torque reference the controller 101 may do two things. First, the controller 101 may store the average torque value and the time as X Torque and X Time, respectively, in memory 111. The controller 101 may then set an X Stroke memory bit to ON. Second, the controller 101 may start the torque sampling again to start the second sub-routine.

In the second sub-routine, when the motor torque rises above the SPM torque reference, the controller 101 may do two things. First, the controller 101 may store the average torque value and the time as X1 Torque and X1 Time, respectively, in the memory 111. The controller 101 may then set the X1 Stroke memory bit to ON. Second, the controller 101 may start the torque sampling again to start the third sub-routine.

In the third sub-routine, when the motor torque drops below the SPM torque reference, the controller 101 may do two things. First, the controller 101 may store the average torque value and the time as Y Torque and Y Time, respectively, in the memory 111. The controller 101 may then set the Y Stroke memory bit to ON. Second, the controller 101 may start the torque sampling again to start the fourth sub-routine.

In the fourth sub-routine, when the motor torque rises above the SPM torque reference, the controller 101 may do two things. First, the controller 101 may store the average torque value and the time as Y1 Torque and Y1 Time, respectively, in the memory 111. The controller 101 may then reset the X, X1, and Y stroke memory bits to OFF. Second, the controller 101 may start the torque sampling again to start the next cycle until the set number of cycles have run.

Referring to FIG. 3C, the controller 101 may start at Al, from FIG. 3B. After the set number of cycles have run (for example, five complete cycles), the controller 101 may determine whether the average torque value for the X torque values to the Y torque values (for example, five X torque values and five Y torque values) are within a set deviation (340). If the values are within a set deviation, the controller 101 may set the XY Torque OK Memory Bit to ON (341). For example, the set deviation may be three percent deviation.

After the set number of cycles have run (for example five complete cycles), the controller 101 may determine whether the cycle time value for the X times to the Y time values (for example, five X time values and five Y time values) are within a set deviation (342). If the values are within a set deviation, the controller 101 may set the XY Time OK Memory Bit to ON (343). For example, the set deviation may be three percent deviation.

After the set number of cycles have run (for example five complete cycles), the controller 101 may determine whether the average torque value for the X1 torque values to the Y1 torque values (for example, five X1 torque values and five Y1 torque values) are within a set deviation (344). If the values are within a set deviation, the controller 101 may set the X1Y1 Torque OK Memory Bit to ON (345). For example, the set deviation may be three percent deviation.

After the set number of cycles have run (for example five complete cycles), the controller 101 may determine whether the cycle time value for the X1 times to the Y1 time values (for example, five X time values and five Y time values) are within a set deviation (346). If the values are within a set deviation, the controller 101 may set the X1Y1 Time OK Memory Bit to ON (347). For example, the set deviation may be three percent deviation.

In general, the above set deviations are set according to an accuracy window. If the deviation percent is too low, the controller 101 would be too restrictive in differentiating between single and dual peak pumps (e.g., errors more than 5% of the time). On the other hand, if the deviation percent is too high, the controller 101 would not be restrictive enough in differentiating between single and dual peak pumps (e.g., errors more than 5% of the time). For example, during testing the accuracy window was determined to be between 2-4%. When the deviation percent was set to 2% or lower, the controller 101 had an error more than 5% of the time. When the deviation percent was set to 4% or greater, the controller 101 had an error more than 5% of the time.

Lastly, the controller 101 may determine whether the pump 105 is a single peak or two peak pump. If all four OK memory bits (XY Torque OK (341), XY Time OK (343), X1Y1 Torque OK (345), X1Y1 Time OK (347)) are ON (348), then the controller 101 may determine that the pump 105 is a single-peak pump (349). If any of the four OK memory bits are OFF, then the controller 101 may determine that the pump 105 is a two-peak pump (330). The controller 101 may store the determination in the memory 111.

FIGS. 4A and 4B are flowcharts for explaining several methods of determining a minimum speed baseline, according to an exemplary embodiment. Referring to FIG. 4A, in the find minimum speed baseline routine (207), the controller 101 may control a motor to a minimum speed (400). The controller 101 may then obtain motor data (401). The controller 101 may then determine a minimum speed baseline based on a type of the pumping system and the motor data (402).

Referring to FIG. 4B, the controller 101 may control a motor to a minimum speed (410). The controller 101 may wait for a set period, then obtain motor data (411). The controller 101 may, for a set number of strokes of the motor, for a stroke of the set number of strokes, calculate an average motor torque, an average motor speed, and a maximum motor torque (stroke data points) based on a type of the pumping system and on the obtained motor data, and store the stroke data points in a memory (412). The controller 101 may calculate an average of each of the stroke data points across the set number of strokes, and store the average of each of the stroke data points as a minimum speed baseline in the memory (413).

In another embodiment, the controller 101 may, for a set number of strokes of the motor, for each stroke of the set number of strokes, calculate an average motor torque, an average motor speed, and a maximum motor torque (stroke data points) based on a type of the pumping system and on the obtained motor data, and store the stroke data points in a memory. The controller 101 may calculate an average of each of the stroke data points across the set number of strokes, and store the average of each of the stroke data points as a minimum speed baseline in the memory.

More specifically, the controller 101 controls the VFD 103 to adjust the speed of the motor 104 to the motor's minimum speed, which may be a preset speed or set by a user via the input device 112 (minimum speed parameter). For example, the minimum speed parameter may be set on the controller's 101 Basic Parameters Screen (not pictured) and stored in memory 111. The controller 101 may wait for a delay to allow time for the pumping system 100 to normalize and then start collecting motor data from the VFD 103. The delay may be 10 seconds. The collected motor data may be stored in the memory 111.

The controller 101 may, for each stroke of the pump 105, calculate the average motor torque, the average motor speed and the maximum motor torque based on the collected motor data. The controller 101 may store each of these three data points into a data structure (not pictured) in memory 111. For example, the three data points may be stored in an array to be used later. The controller 101 may collect data for a set number of strokes. For example, the controller 101 may collect data for five strokes at the minimum speed. The controller 101 may calculate the average of each of the stroke data points and save these as the minimum speed baseline, then the controller 101 may continue to the find normal speed baseline routine (208). For example, the controller 101 may calculate the average of each of stroke data points for five strokes.

FIGS. 5A and 5B are flowcharts for explaining several methods of determining a normal speed baseline, according to an exemplary embodiment. Referring to FIGS. 5A and 5B, the same method as FIGS. 4A and 4B are performed, but the controller 101 may control the motor to a normal speed (500), determine a normal speed baseline based on a type of a pumping system the motor data (502), and calculate an average of each of the stroke data points across the set number of strokes, and store the average of each of the stroke data points as a normal speed baseline in the memory (513).

More specifically, in the find normal speed baseline routine (208), the controller 101 controls the VFD 103 to adjust the speed of the motor 104 to the motor's normal speed, which may be a preset speed or set by a user via the input device 112 (normal speed parameter). The controller 101 may wait for a delay to allow time for the pump 105 to normalize. The delay may be a ten second delay.

The controller 101 may start collecting data for each stroke of the pump 105. The controller 101 may calculate the average motor torque, the average motor speed and the maximum motor torque. The controller 101 may store each of these three data points into a data structure. For example, the data structure may be an array to be used at a later time. The controller 101 may collect data for a set number of strokes. For example, the controller 101 may collect data for five strokes at normal speed.

The controller 101 may calculate the average of each of the stroke data points and the controller 101 may store the averages as the normal speed baseline in the memory 111, then the controller turn the pump-off detection routine ON (209). For example, the controller 101 may calculate the average of each of the stroke data points for five strokes and save these as the normal speed baseline values in memory 111, then the controller 101 may then turn the pump-off detection routine to the ON state (209) from the default OFF state. The controller 101 may then continue to stroke rolling average routine (210).

FIGS. 6A and 6B are flowcharts for explaining several methods of detecting a pump-off event, according to an exemplary embodiment. Referring to FIG. 6A, the controller 101 may obtain motor data and a normal speed baseline of a motor (600). The controller 101 may detect a pump-off event when the motor data deviates from the normal speed baseline (601). The controller 101 may control the motor in response to detecting the pump-off event (602).

Referring to FIG. 6B, the controller 101 may obtain motor data and a normal speed baseline of a motor (610). The controller 101 may calculate, for a stroke of the motor, an immediate motor load based on the motor data (611). The controller 101 may detect a pump-off event when the immediate motor load is less than the normal speed baseline by a set percent of the normal speed baseline (612). The controller 101 may control the motor to a minimum speed or to a stop (613).

In another embodiment, the controller 101 may calculate, for each stroke of the motor, an immediate motor load based on the motor data. The controller 101 may detect a pump-off event when the immediate motor load is less than the normal speed baseline by a set percent of the normal speed baseline. The controller 101 may control the motor to a minimum speed or to a stop.

FIGS. 7A and 7B are flowcharts for explaining several methods of determining a rolling average of an average motor torque, according to an exemplary embodiment. Referring to FIG. 7A, the controller 101 may obtain motor data (700). The controller 101 may calculate, for each stroke of a motor, an average motor torque based on the obtained motor data (701). The controller 101 may calculate, for each stroke of the motor, a rolling average based on previous average motor torques (702). The controller 101 may determine whether to run the Find Min Speed Baseline Routine and the Find Normal Speed Baseline Routine based on the average motor torque and the rolling average (703).

In another embodiment, the controller 101 may calculate, for each stroke of a motor, an average motor torque based on the obtained motor data. The controller 101 may calculate, for each stroke of the motor, a rolling average based on previous average motor torques. The controller 101 may determine whether to run the Find Min Speed Baseline Routine and the Find Normal Speed Baseline Routine based on the average motor torque and the rolling average.

Referring to FIG. 7B, the controller 101 may obtain motor data (710). The controller 101 may calculate, for a stroke a motor, an average motor torque based on the obtained motor data (current stroke value) (711). The controller 101 may calculate, for the stroke the motor, an average of previous average motor torques (previous stroke value) stored in a first-in first out array in a memory (712). The controller 101 may compare current stroke value with previous stroke value (713). If the controller 101 determines that the current stroke value is greater than the previous stroke value by a set percent of the previous stroke value (714), the controller 101 may run a Find Min Speed Baseline Routine and a Find Normal Speed Baseline Routine (715). If controller 101 determines that the current stroke value is less than or equal to the previous stroke value by a set percent of the previous stroke value (716), the controller 101 may store the current stroke value in the first-in first-out array, then return to obtain motor data and repeat sequence (717).

In another embodiment, the controller 101 may calculate, for each stroke of a motor, an average motor torque based on the obtained motor data (current stroke value). The controller 101 may calculate, for each stroke the motor, an average of previous average motor torques (previous stroke value) stored in a first-in first out array in a memory.

More specifically, in the stroke rolling average routine (210), the controller 101 may, for each stroke the pump 105 completes, calculate an average motor torque, an average motor speed and a maximum motor torque for that stroke (current stroke values) and the controller 101 may store the current stroke values in a data structure in memory 111 (stroke data). For example, the data structure may be an array. The array may be a first-in first-out array such that the current stroke value will replace the oldest stroke value. The controller 101 may store stroke data for a set number of strokes. For example, the controller may store five values in the array. The controller 101 may calculate the average of the stroke data in the array. For example, the controller 101 may calculate the average of the five values in the array. The controller 101 may then continue to a deviation testing routine (211).

However, before the current stroke values are saved into the array, the controller 101 may compare the current stroke values against the average of stroke data already loaded into the array. For example, the average of five values in the array. If the current stroke data is more than the average of the array by a set percent of the average of the array, the controller 101 may repeat the find minimum speed baseline routine (207) and the find normal speed baseline routine (208). The set percent may be three percent. The controller 101 may then continue to the deviation testing routine (211).

FIGS. 8A and 8B are flowcharts for explaining several methods of detecting deviation, according to an exemplary embodiment. Referring to FIG. 8A, the controller 101 may obtain, for a stroke of a motor, current stroke data (800). The controller 101 may compare, for the stroke of the motor, current stroke data to a normal speed baseline (801). The controller 101 may trigger an alarm condition, if the current stroke data is more than an allowed deviation from the normal speed baseline (802).

In another embodiment, the controller 101 may obtain, for each stroke of a motor, current stroke data. The controller 101 may compare, for each stroke of the motor, current stroke data to a normal speed baseline. The controller 101 may trigger an alarm condition, if the current stroke data is more than an allowed deviation from the normal speed baseline.

Referring to FIG. 8B, the controller 101 may obtain, for a stroke of a motor, current stroke data (810). The controller 101 may determine if an average torque parameter is active (811). If not, the controller 101 may return to obtain, for a stroke of the motor, current stroke data (810). If the average torque parameter is active, the controller 101 may continue to Test for % Deviation in Peak (812), and Test for % Deviation Average Torque (813), Test for % Deviation Average RPM (814). The controller 101 may trigger an alarm condition if any one of the tests indicates deviation (815). The alarm condition may be that a pump-off event has occurred in the pumping system 100.

In another embodiment, the controller 101 may obtain, for each stroke of a motor, current stroke data (810).

More specifically, in the deviation testing routine (211), the controller 101 may compare, for each stroke of the pump 105, the current stroke data to the normal speed baseline. If the current stroke data is more than an allowed deviation, the controller 101 may trigger an alarm condition. The allowed deviation is determined by a Pump Off Sensitivity parameter. For example, the controller 101 may test for a percent deviation in peak, a percent deviation of average torque, and a percent deviation of average rotations per minute (RPM) of the motor 104.

To test for a percent deviation in peak, the controller 101 may determine whether a peak torque of the current stroke data does not reach a normal speed baseline peak torque minus a percent of the normal speed baseline torque. If the peak torque of the current stroke data does not reach the normal speed baseline peak torque minus the percent of the normal speed baseline torque, the controller 101 determines that the test indicates deviation; otherwise the controller 101 determines that the test passes. To test for a percent deviation average torque, the controller 101 may determine whether an average torque of the current stroke data is more than a percent deviation from an average torque of the normal speed baseline. If the average torque of the current stroke data is more than a percent deviation from the average torque of the normal speed baseline, the controller 101 determines the test indicates deviation; otherwise, the controller 101 determines that the test passes. To test for a percent deviation average RPM, the controller 101 may determine whether an average RPM of the current stroke data is more than a percent deviation from an average RPM of the normal speed baseline. If the average RPM of the current stroke data is more than a percent deviation from the average RPM of the normal speed baseline, the controller 101 determines the test indicates deviation; otherwise, the controller 101 determines that the test passes.

FIGS. 9A, 9B, 9C, 9D, 9E, 9F, 9G, and 9H are views for explaining a method of SPM calibration, according to an exemplary embodiment. Referring to FIG. 9A, the controller 101 may set a default SPM torque reference in relation to an obtained motor torque, as a function of time. For example, the SPM torque reference may be equal to 25%.

Referring to FIG. 9B, when controller 101 detects that the motor torque rises above the SPM torque reference, torque sampling begins and the controller 101 captures the highest value seen until the motor torque drops below the SPM torque reference.

Referring to FIGS. 9C and 9D, the controller 101 may determine the first peak value to be SPM Peak X and the value could be captured and stored as SPM Peak X in memory 111. The same process could be repeated with even intervals being labeled as SPM Peak Y. Both SPM Peak X and Y could be addressed and displayed on a diagnostic screen of output device 113. The controller 101 may continue the process for a set period or the controller 101 may continuously sample the peak values. The controller 101 may perform several tests to ensure that the controller is sampling different peaks and not the same peaks in both the X and Y intervals.

Referring to FIG. 9E, the controller 101 may calculate a running average of a set number of X peaks and a same number of Y peaks. For example, the X running average may be of the last 5 samples of X and the Y running average may be of the last 5 samples of Y. The controller 101 may compare the X running average with the Y running average. The controller 101 may determine that, if the difference is greater than a set percentage between the X peaks and Y peaks, the torque sampling has two different peaks (balanced well). For example, the set percentage may be 10%.

The controller 101 may then determine the stroke period by timing the period of each stroke. For example, the controller 101 may determine period by starting a timing function on each falling edge of the motor torque VS the SPM torque reference for each of the X peaks and Y peaks (if the torque sampling has two different peaks). The controller 101 may also compare SPM average peak of X and Y, as well as SPM stroke time X and SPM stroke time Y.

Referring to FIG. 9F, the above process would indicate that both motor torque samples show the X and Y peak values are within 10%. The single peak graph would read the proper SPM and the balanced well would read exactly ½ the actual SPM or 2 times actual stroke time.

Referring to FIG. 9G, one solution for the problem presented by FIG. 9F is to require feedback. The controller 101 may use a Unit Balance parameter to request a simple observation. For example, the controller may assume any value below 30% is disregarded, and the above process would yield a “Single Peak” condition such that the controller 101 would calculate SPM Stroke Time X as the time from falling edge X to falling edge Y, the SPM Stroke Time Y is falling edge Y to falling edge X.

Another way to test for this condition is to compare the times the peaks are above the SPM torque reference. In a single-peak well the times above reference should be near similar each sample. In a balanced well the times should be somewhat different. Therefore, the controller 101 may compare the periods of time the motor torque is above the SPM torque reference in order to determine whether the pump 105 is a single-peak or a two-peak pump.

Referring to FIG. 9H, the above process works well with a single low load, as it is another challenge that the above process will catch and calculate SPM correctly. The controller 101 will determine it like a single peak and calculate the SPM/Speed X to Y correctly.

FIGS. 10A and 10B are views for explaining a method of reducing the amount of regenerated DC bus voltage, according to an exemplary embodiment. FIG. 100 is a flowchart for explaining a method of reducing the amount of regenerated DC bus voltage, according to the exemplary embodiment disclosed in FIGS. 10A and 10B. In standard overvoltage controllers, for example the standard overvoltage controller supplied by Vacon, when the DC Bus increases beyond a fixed (internal to Vacon's controller) level the overvoltage controller will take command of the speed reference increasing the output frequency to bring the DC Bus under control.

Referring to FIG. 10A, FIG. 10A shows the overvoltage controller in operation. The trigger level for it to turn on is about 750 VDC. FIG. 10A shows that the trigger operates during some voltage spikes but not others. The small blue spikes are when the drive increases speed (indicated by blue arrow) during the highest spikes (indicated by red arrow). The green arrow points out the lower spikes where the drive is not increasing speed.

Using the overvoltage control works well, but it does not do so well in areas where there are line voltages over 500 VAC. When this higher line voltage is present some challenges become very apparent. The issues involved in controlling a beam pump are like a triangle, with the three legs being supply voltage, unit balance and unit speed. The pumping system 100 may perform adequately with an issue for one of these items but not more. If the supply voltage is high, the pump system 100 cannot run too fast or be too out of balance. If the unit speed is fast, the pump system 100 cannot have a high line voltage or be too out of balance. If the unit balance is bad, the pump system 100 cannot have a high line voltage or the unit cannot run too fast.

Standard solutions to the problem of high supply voltage are to spend money to balance the pump system 100 or spend money to install a buck/boost transformer which is only marginally less expensive to install.

Another problem is that DC Bus voltage may rise before any action is taken to correct it. The overvoltage controller does not attempt to do anything until the voltage reaches about 750 VDC or higher, and the trigger occurs at around 825 VDC. Therefore, having a high line voltage shortens the amount of time the pump system 100 has to respond to the rising voltage, thereby forcing the pump system 100 to or over the trigger level, thereby reducing the amount of tolerance the pump system 100 has to other challenges.

Referring to FIG. 10B, the controller 101 may proactively control the regeneration from the motor 104. The controller 101 may use a minimum torque reference to allow the pump 105 to accelerate to keep from tripping from the regenerated voltage of the motor 104. Specifically, the controller 101 may increase the motor speed slightly before the motor 104 reaches negative torque. For example, the minimum torque reference could set to 5% or 8% to thereby put tension on the motor 104/gearbox (not depicted)/pump 105 to eliminate or reduce any regenerated voltage.

Referring to FIG. 100, the controller 101 may obtain, for a stroke of a motor, current stroke data (1000). The controller 101 may compare, for the stroke of the motor, current stroke data to a minimum torque reference (1001). The controller 101 may control the motor to increase the motor speed before the motor reaches the minimum torque reference (1002).

In another embodiment, the controller 101 may obtain, for each stroke of a motor, current stroke data. The controller 101 may compare, for each stroke of the motor, current stroke data to a minimum torque reference. The controller 101 may control the motor to increase the motor speed before the motor reaches the minimum torque reference.

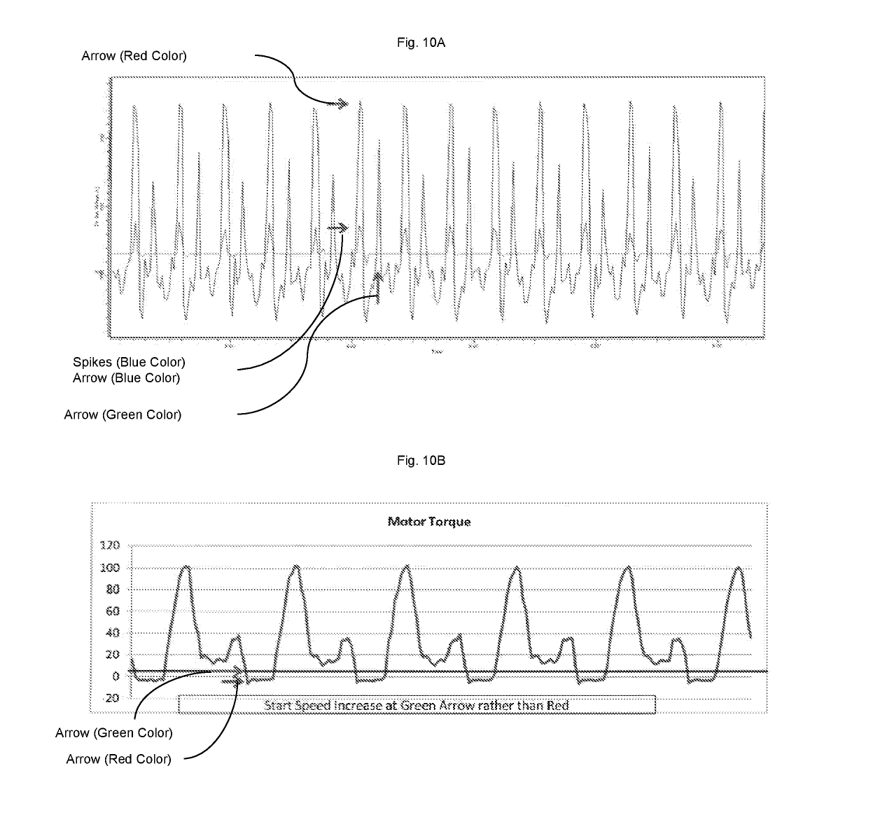

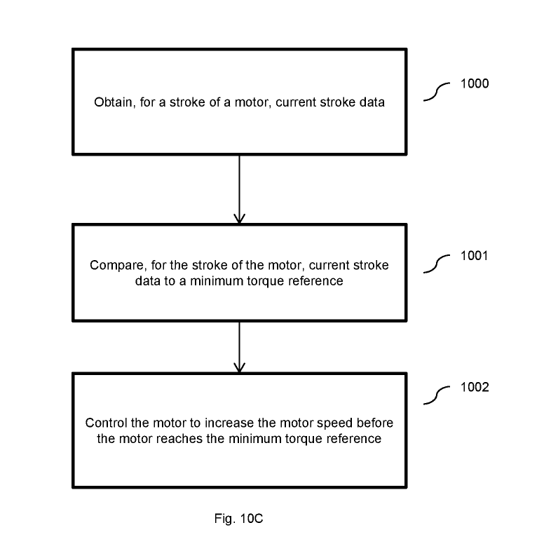

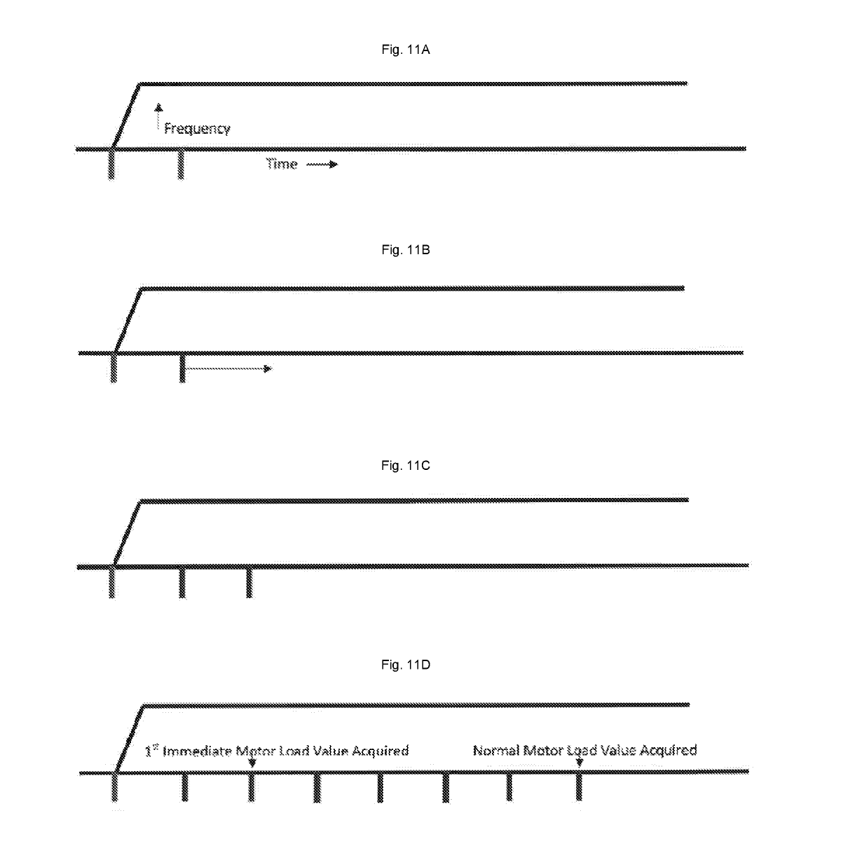

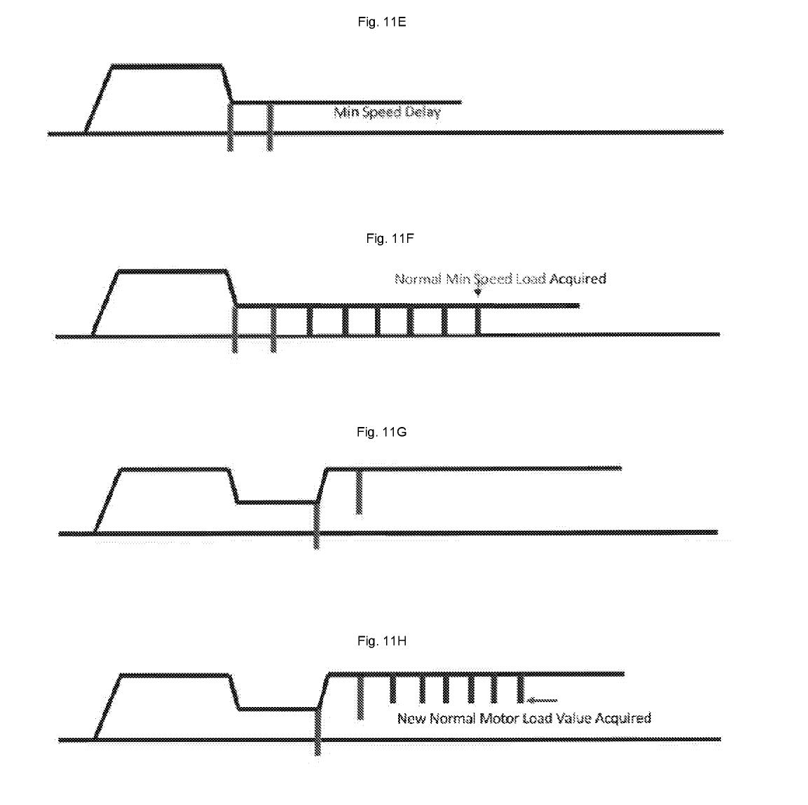

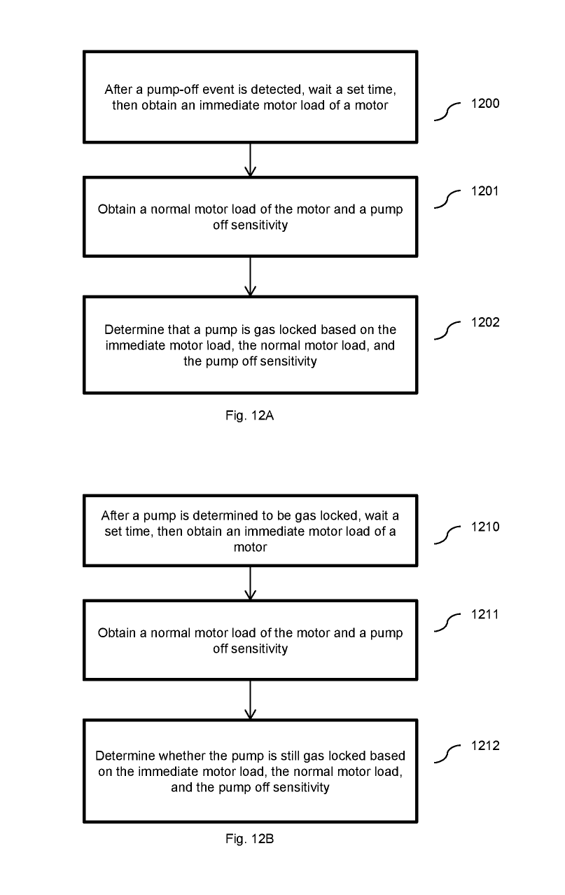

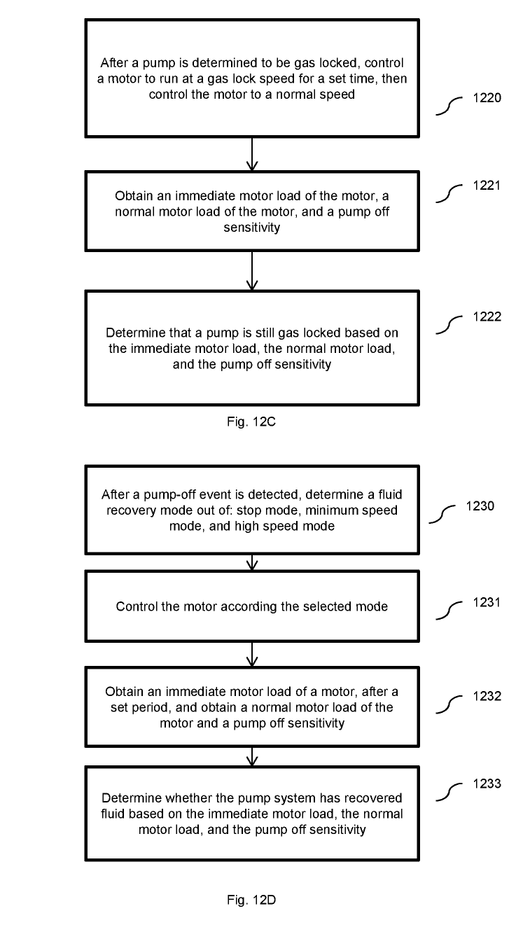

FIGS. 11A, 11B, 11C, 11D, 11E, 11F, 11G, and 11H are views for explaining a method of controlling a pumping system, according to an exemplary embodiment. Referring to FIG. 11A, the pump system 100 controller 101 is started with Pump-Off Software turned “ON”. The controller 101 may wait a period equal to a Pump Off Delay parameter. For example, the delay may be a minimum of 2 minutes. No torque data is collected for the period of Pump Off Delay parameter. The Pump Off Delay parameter is to allow the pump 105 to work any gas out and for the pump 105 to obtain normal SPM before data is collected.

Referring to FIG. 11B, after the delay, the controller 101 runs two parallel routines: Routine #1 Peak Load Detection Routine and Routine #2 Average Torque Detection Routine (when turned on).

Referring to FIG. 11C, in the Peak Load Detection Routine, the controller 101 samples the motor torque and stores the maximum motor torque value recorded after the delay period in memory 111. The controller 101 compares every motor torque value after to the stored value. If the current value is higher than the stored value, the controller 101 may replace it. If the current value is within the Pump Off Sensitivity, the controller 101 may reset a watchdog timer. The watchdog timer may be set to the value of a Detect Delay parameter. If the motor torque value is less than the Pump Off Sensitivity, the controller 101 does not reset the watchdog timer. If the watchdog timer ever times out, then the controller 101 may detect a pump-off condition, and the controller 101 may change a Status of Pump-Off Peak=1.

The Peak Load Detection Routine may have no other time limits and can run for hours or days. It is simple and represents the first steps at detecting a pump-off. The Peak Load Detection Routine detects pump-offs on exceedingly well on counterweight pumps, thereby allowing for an extra bit of safety factor should a pump-off occur within the first few minutes of pumping system 100 activity.

Referring to FIG. 11D, in Average Torque Detection Routine, the controller 101 samples the motor torque a set number of times a second (e.g., 10× a second) and divides the sum of the sample torque values by the number of samples taken. The number of samples taken may be determined by the stroke of the motor 105. The controller 101 therefore runs a Torque Averaging routine. For each period set by the stroke of the motor 105, the controller 101 calculates a new Immediate Motor Load by running the torque averaging routine. The new average torque may be stored in memory 111. Further, the controller 101 may display the new average torque on the output device 113 as the “Immediate Motor Load”.

The controller 101 may obtain an initial set number of “Immediate Motor Load” values and average them to create the “Normal Motor Load”. For example, the set number may be the first five “Immediate Motor Load” values. It may take five-time cycles for the “Normal Motor Load” to be calculated and the controller 101 may display the “Normal Motor Load” on the output device 113 on the sixth-time cycle.

After the controller 101 calculates the “Normal Motor Load”, the controller 101 may activate the Average Torque Pump-Off Detection routine.

In the Average Torque Pump-Off Detection routine, the controller 101 may, at the acquisition of the Normal Motor Load value and every time cycle after it, compare the Immediate Motor Load value to the Normal Motor Load. The Normal Motor Load may never be changed until a Pump-Off condition is called. The controller 101 may detect a pump-off condition anytime the Immediate Motor Load value is less than (by default) the Normal Motor Load times Pump Off Sensitivity value. The controller 101 may be set to a default setting for the Average Torque Pump Off Detection Mode such that “Less Than” is the default setting. That said, the controller 101 may toggle between “Less Than”, “Greater Than” and “Either” by user input from input device 112, which can be stored in memory 111.

For example, the Normal Motor Load stored is 45.6% and a Pump Off Sensitivity is set to 85%, then a pump-off would be called anytime the Average Torque (Immediate Motor Load) went below 38.7%.

Once the controller 101 detects a pump-off, the controller 101 looks to a Pump Off Action parameter to determine what action to take. The controller 101 may have two options: Option #1 Stop Motor or Option #2 Minimum Speed.

In Option #1 Stop Motor, the controller 101 controls the VFD 103 to stop the motor 104 for a set amount of time defined by a Pump Off Stop Time. For example, Pump Off Stop Time could be 1 minute to 1440 minutes.

Referring to FIG. 11E, in Option #2 Minimum Speed, the controller 101 controls the VFD 103 to slow the motor 104 down to the minimum speed for the amount of time defined by the Min Speed Time parameter. For example, the Min Speed Time parameter may be 1 minute to 1440 minutes. After a pump-off is detected, the controller 101 controls the VFD 103 to slow the motor 104 to the Minimum Speed to observe the delay as set by the Min Speed Time parameter to allow the pump to clear any gas from the pump before data is collected.

Once the delay is complete, the controller 101 may run the Average Torque routine to acquire a value for Normal Minimum Speed Load, using the same set number of time cycles as the Immediate Motor Load described above. The controller 101 may store the Normal Minimum Speed Load in memory 111, until reset.

When the Min Speed Time parameter has timed out (or the Pump Off Stop Time, for Stop Motor action), the controller 101 may allow the pump system 100 to increase speed of the motor 104 to normal speed.

The controller 101 may allow a user to increases/decreases the Pump Off Stop Time or Min Speed Time based on a pump-off action to obtain a desired runtime of the pump system. The controller 101 may determine that, if the runtime is short by a percentage, that percentage is added to the Pump Off Stop Time or Min. Speed time. The controller 101 may determine that, if the runtime is long by a percentage, that percentage is subtracted from the Pump Off Stop Time or Min. Speed time.

The controller 101 may allow a user to increases/decreases the Pump Off Stop Time or Min. Speed time based on Pump Off action to obtain a desired number of Pump Offs Per Day. The controller 101 may set a target time interval between pump off. If the measured time interval is short by a percentage, that percentage is added to the Pump Off Stop Time or Min. Speed time. If the measured time interval is long by a percentage, that percentage is subtracted from the Pump Off Stop Time or Min. Speed time.

Referring to FIG. 11H, after the Pump Off Delay is complete, controller 101 may start the data collection for pump-off detection by gathering all New pump-off data as described above, and a new “Normal Motor Load” is obtained.

During Minimum Speed operation and at Normal Speed after the first pump-off occurs, controller 101 may use four functions to control of the pump system 100. The four functions, when enabled, may use the Torque Averaging routine. The four routines may use the same delays and the same sample periods, but the four routines could have adjustable delays and sample periods. The four functions are: (1) Leak/Pump Wear Detection, (2) Waxing Detection, (3) Gas Lock Detection and (4) Fluid Recovery Failure Detection (Min. Speed Mode). A user may enable/disable the four functions by the input device 112.

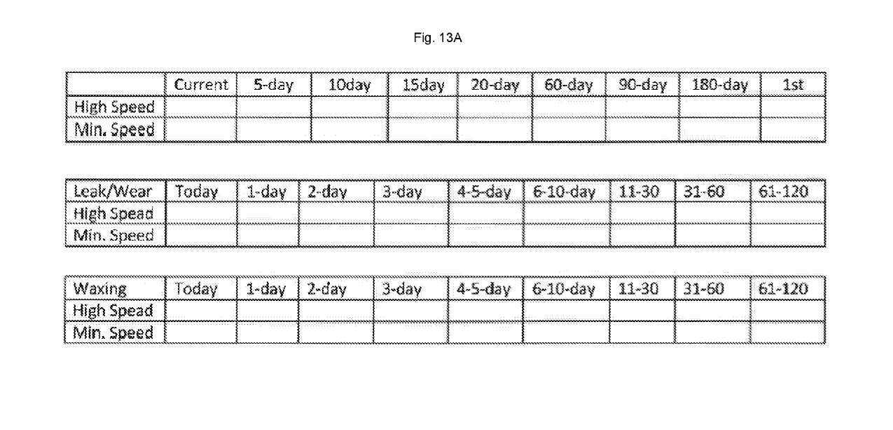

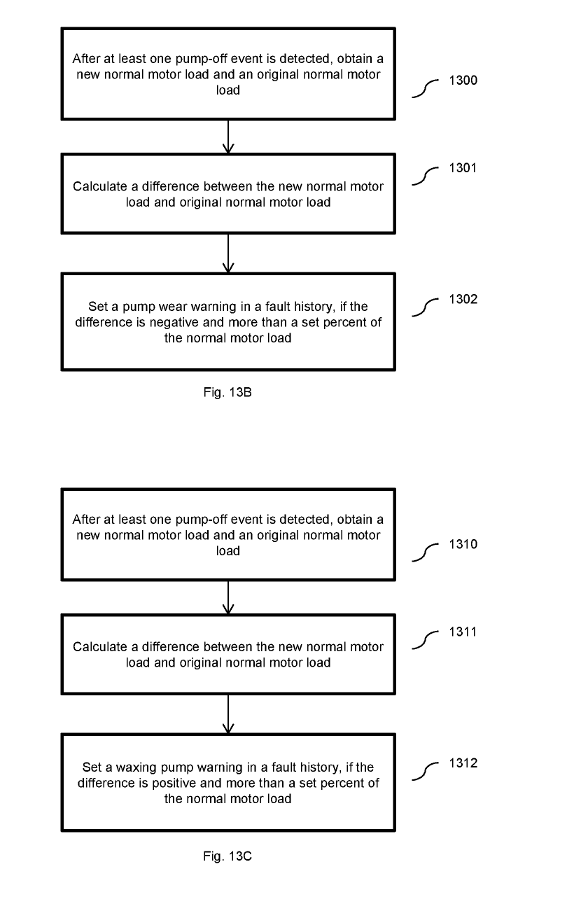

FIGS. 12A, 12B, 12C and 12D are flowcharts for explaining a method of controlling a pumping system, according to an exemplary embodiment.

Referring to FIG. 12A, the controller 101 may, after a pump-off event is detected, wait a set time, then obtain an immediate motor load of a motor (1200). The controller 101 may obtain a normal motor load of the motor and a pump off sensitivity (1201). The controller 101 may determine that a pump is gas locked based on the immediate motor load, the normal motor load, and the pump off sensitivity (1202).

More specifically, in the Gas Lock Detection function, by storing a previous “Normal Motor Load” Value in memory 111, the controller 101 can determine whether a gas lock has occurred. For example, Normal Motor Load was 45.6% and a Pump Off Sensitivity of 85%, then a pump-off would be called anytime the Immediate Motor Load went below Normal Motor Load times Pump Off Sensitivity, 38.7%. For example, the Immediate Motor Load came in at 36.0% to generate the previous pump-off. The controller 101 slowed the pump 105 down and now its sped backup or started, and the controller 101 waits through the Pump Off Delay period and then the Torque Sampling routine starts running again.

The controller 101 then obtains the first Immediate Motor Load. If the first Immediate Motor Load comes in above 38.7%, which is within our Pump Off Sensitivity, the controller 101 takes no action as the pump 105 is working normally and was able to clear the gas from the pump 105. If the first Immediate Motor Load comes in below 38.7%, a value low enough to have caused a Pump-off in the previous cycle, the controller 101 can detect that the pump is gas locked (or possibly still Pumped Off, which will be covered in Fluid Recovery Failure Detection below) and is showing a pumped-off waveform. The controller 101 may then enter Gas Lock Mode if Enabled, and the controller 101 may display a Gas Lock Warning in the Fault History.

In the Gas Lock Mode, the controller 101 may perform a Wait and Monitor routine or Increase Speed routine. The Gas Lock Attempt to Clear Time may be 0 minutes to 60 minutes. (Wait and Monitor). The Gas Lock Speed Time may be 0 minutes to 30 and the Gas Lock Speed Attempts may be 0 to 10.

Referring to FIG. 12B, the controller 101 may, after a pump is determined to be gas locked, wait a set time, then obtain an immediate motor load of a motor (1210). The controller 101 may obtain a normal motor load of the motor and a pump off sensitivity (1211). The controller 101 may determine whether the pump is still gas locked based on the immediate motor load, the normal motor load, and the pump off sensitivity (1212).

More specifically, in the Gas Lock Mode, Wait and Monitor routine, the controller 101 will continue to calculate Immediate Motor Load to determine if they have returned to a normal level as compared to the previous Normal Motor Load within a Gas Lock Clear Time, then the controller 101 may set a “Gas Lock Failure Warning” in the Fault History. When an Immediate Motor Load finally rises above the Pump Off Sensitivity, the controller 101 may run the Average Torque Pump Off Detection routine and may set a “Gas Lock Cleared” message in the fault history.

In the Gas Lock Mode, Wait and Monitor routine, the controller 101 will continue to calculate Immediate Motor Load to determine if the Immediate Motor Load returns to a normal level with in the Gas Lock Clear Time. The controller 101 then may set a “Gas Lock Cleared” message in the Fault History, and the controller 101 may run the Average Torque Pump Off Detection routine.

Referring to FIG. 12C, the controller 101 may, after a pump is determined to be gas locked, control a motor to run at a gas lock speed for a set time, then control the motor to a normal speed (1220). The controller 101 may obtain an immediate motor load of the motor, a normal motor load of the motor, and a pump off sensitivity (1221). The controller 101 may determine that a pump is still gas locked based on the immediate motor load, the normal motor load, and the pump off sensitivity (1222).

More specifically, in the Gas Lock Mode, Increase Speed routine, the controller 101 may increase the speed of the motor 104 up to a Gas Lock Speed Reference for the Gas Lock Speed Time. The controller 101 may then return the motor 104 to the normal speed and the controller 101 may run the Average Torque routine.

In the Gas Lock Mode, Increase Speed routine, if the Immediate Motor Loads have not returned to a normal level, then the controller 101 may set “Gas Lock Attempt Failure” in the Fault History and the controller 101 may subtract 1 attempt is subtracted from the attempts count. If there are attempt/s left in the counter, the controller 101 runs the process again. If there are Zero attempts left, then the controller 101 sets a “Gas Lock Speed Failure Warning” in the fault History. The motor 104 is not stopped or faulted; it continues to run, and the controller 101 continues monitoring the Immediate Motor Load and comparing the results to the Previous Normal Motor Load. When an Immediate Motor Load finally rises above the Pump Off Sensitivity, the controller 101 may run the Average Torque Pump Off Detection routine and the controller 101 may set a “Gas Lock Cleared” in the fault history.

In the Gas Lock Mode, Increase Speed routine, if the Immediate Motor Load returns to a normal level, the controller may set a “Gas Lock Speed Cleared” message in the Fault History and the controller 101 may run the Average Torque Pump Off Detection routine.

Referring to FIG. 12D, the controller 101 may, after a pump-off event is detected, determine a fluid recovery mode out of: stop mode, minimum speed mode, and high speed mode (1230). The controller 101 may control the motor according the selected mode (1231). The controller 101 may obtain an immediate motor load of a motor, after a set period, and obtain a normal motor load of the motor and a pump off sensitivity (1232). The controller 101 may determine whether the pump system has recovered fluid based on the immediate motor load, the normal motor load, and the pump off sensitivity (1233).

In the Fluid Recovery Detection function, the controller 101 may allow a user to enable/disable the function. If Gas Lock Detection is Enabled, the controller 101 may wait until the Gas Lock Detection routine has failed before the controller 101 activates the Fluid Recovery Failure Detection routine. If Gas Lock Detection routine does not fail, the controller 101 may run the Pump Off routine and the Fluid Recovery Failure Detection routine is not run.

More specifically, in the Fluid Recovery Detection function, the controller 101 may have three Fluid Recovery modes: Stop Motor Mode, Minimum Speed Mode, and High Speed mode. The Fluid Recovery Detection function may have a Fluid Recovery Time that may be 1 minute to 240 minutes. The Fluid Recovery Detection function may have a set number of Fluid Recovery Attempts: that may be 0 to infinite loop. The controller may allow a user, by the input device 112, to select which mode the Fluid Recovery Detection function operates in; how long the Fluid Recovery Time is; and how many Fluid Recovery Attempts are allowed.

If the Immediate Motor Loads have not returned to a normal level when the first sample is taken, then the controller 101 may set a “Fluid Recovery Warning” in the Fault History.

In the Fluid Recovery Detection function, Stop Motor Mode, the controller 101 may stop the motor 104 for the Fluid Recovery Time. At the end of that time, controller 101 may return motor 104 to high speed and 1 attempt is removed from the Attempts counter. The controller 101 may sample the Immediate Motor Load is again. If Motor Load is normal, the controller 101 may run the Average Torque Pump Off Routine and the controller may set a “Fluid Recovery Successful” message in the fault history. The controller 101 may then reset the Fluid Recovery Attempts to the user input value.

If Motor Load is not normal, then, if the counter then reads 0, the controller 101 may set a “Fluid Recovery Failure Fault (Stop)” message in the fault history and the controller 101 may stop the motor 104 as it is a faulting pumping system. Otherwise, the controller 101 runs the Fluid Recovery Detection function, Stop Motor Mode, sequence again.

In the Fluid Recovery Detection function, Min. Speed Mode, the controller 101 may run the motor 104 at Min. Speed for the Fluid Recovery Time. At the end of that time, the controller runs the motor 104 at high speed and 1 attempt is removed from the Attempts counter. The controller 101 may sample the Immediate Motor Load is again. If Motor Load is normal, the controller 101 may run the Average Torque Pump Off Routine and the controller may set a “Fluid Recovery Successful” message in the fault history. The controller may then reset the Fluid Recovery Attempts to the user input value.

If Motor Load is not normal; then, if the counter then reads 0, the controller 101 may set a “Fluid Recovery Failure Fault (Ministered)” message in the fault history and the controller 101 may run the Fluid Recovery Detection function, Motor Stop Mode. Otherwise, the controller 101 runs the Fluid Recovery Detection function, Min. Speed Mode, sequence again.

In the Fluid Recovery Detection function, High Speed Mode, the controller 101 may run the motor 104 at High Speed for the Fluid Recover Time and the controller 101 monitors the Immediate Motor Loads. Should the Immediate Motor Loads recover to expected levels, the controller 101 runs the Average Torque Pump Off Routine and the controller 101 may set a “Fluid Recovery Pump Off Reset” message in the fault history.

FIG. 13A is a view for explaining a method of leak detection, pump wear, and waxing detection; and FIGS. 13B and 13C are flowcharts for explaining a method of leak detection, pump wear, and waxing detection. In general, if a motor load requirement goes up over time that represents changes in well conditions, which could point to paraffin or build up in the tubing thereby restricting fluid flow. In general, reductions over time would point to loss of efficiency in pump performance or leaks that are limiting the fluid getting to the surface.

Further, at this point in the pump system 100 lifespan, the pump system 100 has had at least one pump-off and possibly at least one minimum speed mode. The first Normal Motor Load that was captured and, if applicable as the user may not have enabled the setting, the Normal Minimum Speed Load may be stored in memory 111 until reset.

Referring to FIG. 13A, the controller 101 may display a Leak/Wear & Waxing page on the output device 113. The controller 101 may display the first Normal Motor Load and, if applicable, the Normal Minimum Speed Load may be displayed along with the most recent and historical values, in this case stored in the first positions on the far right. The displayed first Normal Motor Load and, if applicable, the Normal Minimum Speed Load may be the average of the first few occurrences. The controller 101 may display the Normal and Minimum Speed Motor Loads as an average of that day's values, i.e., on 90-Day is the average of that day's values.

The controller 101 may also display the total warnings each day of the range for Leak/Wear as determined by the Leak/Wear Level routine and the total warnings each day of the range for Waxing routine.

Referring to FIGS. 13B and 13C, the Leak/Wear Level routine may have a Leak/Wear Level. The Leak/Wear Level may be between −10 to −40%, as selected by the user via the input device 112. The Waxing Level routine may have a Waxing Level. The Waxing Level may be between +10 to +40%, as selected by the user via the input device 112.

Referring to FIG. 13A, the controller 101 may after at least one pump-off event is detected, obtain a new normal motor load and an original normal motor load (1300). The controller 101 may calculate a difference between the new normal motor load and the original normal motor load (1301). The controller 101 may set a pump wear warning in a fault history, if the difference is negative and more than a set percent of the normal motor load (1302).

Referring to FIG. 13B, the controller 101 may after at least one pump-off event is detected, obtain a new normal motor load and an original normal motor load (1310). The controller 101 may calculate a difference between the new normal motor load and the original normal motor load (1311). The controller 101 may set a waxing pump warning in a fault history, if the difference is positive and more than a set percent of the normal motor load (1312).

More specifically, in the Leak/Wear Level routine, the controller 101 may compare every new Normal Motor Load and, if applicable, Minimum Speed Load to the first Normal Motor Load and Minimum Speed Load, respectively. If the difference is outside of the Leak/Wear Level, the controller 101 may set a “Leak/Pump Wear Warning” message in the fault history.

In the Leak/Wear Level routine, the controller 101 compares every new Normal Motor Load and, if applicable, Minimum Speed Load to the first Normal Motor Load and Minimum Speed Load, respectively. If the difference is outside of the Waxing Level, the controller 101 may set a “Waxing Warning” message in the fault history.

Generally, the fault history may be stored in the memory 111 and the fault history may be displayed on a fault history page on the output device 113.

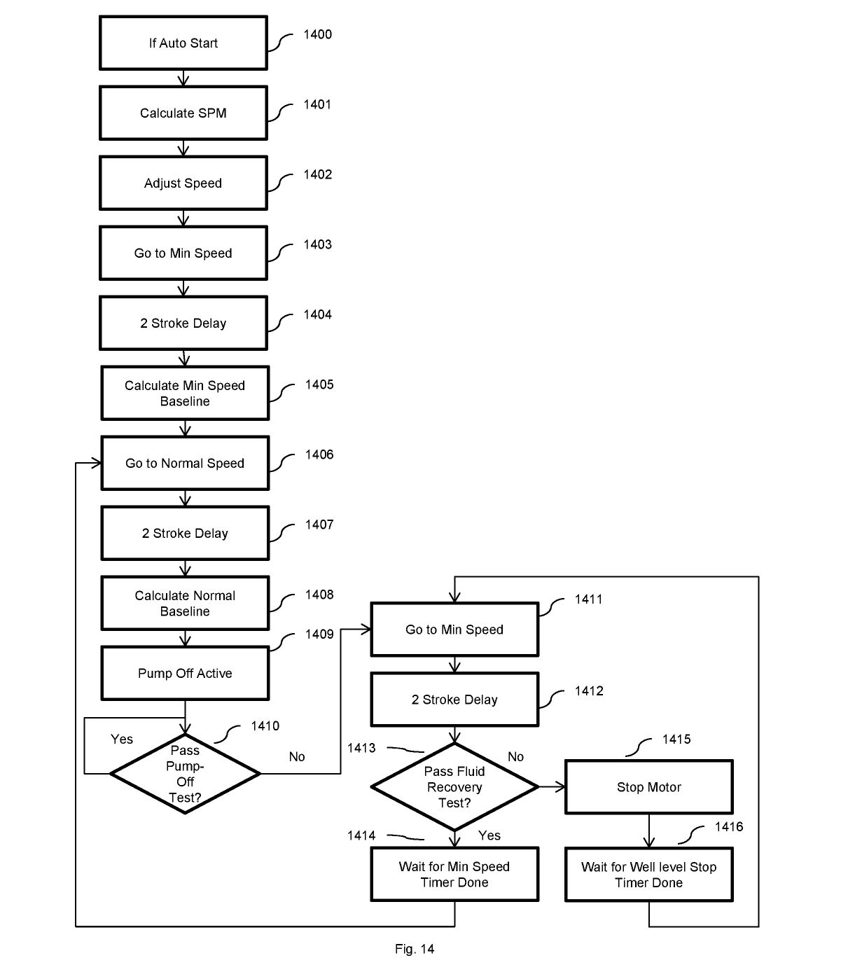

FIG. 14 is a flowchart for explaining a method of controlling a pumping system, according to an exemplary embodiment. Referring to FIG. 14, the controller 101 may auto start once power is applied to the pump system 100 by the power source 106 (1400).

The controller 101 may then calculate SPM torque reference and run the SPM calibration routine (1401). To find the SPM torque reference, the controller 101 may control the VFD 103 to run the motor 105 at full speed (for example, at 60 Hz) for 120 seconds. Generally, 120 seconds is adequate to capture 2 strokes worth of motor data, if pump 105 and motor 104 are configured to run at 2 SPM at, for example at 60 Hz. The controller 101 obtains motor data. If an instantaneous torque value of the motor data is greater than a max torque value, the controller 101 may replace the max torque value with the instantaneous torque value. If an instantaneous torque value of the motor data is less than a min torque value, the controller 101 may replace the min torque value with the instantaneous torque value. After the 120 seconds are complete, the controller 101 may find an average of the min torque value and the max torque value. The controller 101 may set the SPM torque reference as 15% of the average of the min torque value and max torque value. Then, the controller 101 may run the SPM calibration routine.

The controller 101 may adjust an output speed of the VFD 103 (1402). The controller 101 may adjust an output speed of the VFD 103 to match a normal speed set point from memory 111, as set by a user by the input device 112. All speed set points are entered in stroke per minute (SPM) format. The controller 101 may use a basic point/slope equation to scale SPM format to frequency output to the VFD 103.

The controller 101 may adjust the output speed of the VFD 103 to a min speed set point from memory 111, as set by a user by the input device 112 (1403). The controller 101 may allow the pumping system 100 to run at min speed for two strokes to allow time for the pump 105 to stabilize (1404). The controller 101 may then calculate a min speed baseline (1405). Specifically, the controller 101 may then capture motor data. The controller 101 may capture five samples of motor data per second and the controller 101 may average the instantaneous torque values over the period of one stroke (stroke average). The controller 101 may collect five stroke averages and calculate the average of the five stroke averages, and store the average of the five stroke averages as the min speed baseline.

The controller 101 may adjust the output speed of the VFD 103 to a normal speed set point from memory 111, as set by a user by the input device 112 (1406). The controller 101 may allow the pumping system 100 to run at normal speed for two strokes to allow time for the pump 105 to stabilize (1407). The controller 101 may then calculate a normal speed baseline (1408). Specifically, the controller 101 may then capture motor data. The controller 101 may capture five samples of motor data per second and the controller 101 may average the instantaneous torque values over the period of one stroke (stroke average). The controller 101 may collect five stroke averages and calculate the average of the five stroke averages, and store the average of the five stroke averages as the normal speed baseline.

The controller 101 may activate the pump-off test (1409). The controller 101 may determine if the pump-off test has been passed (1410). The pump-off test may, for each stroke compare stroke average torque (an average of the instantaneous torque over the course of one stroke) to the normal speed baseline. If the stroke average torque is less than the normal speed baseline multiplied by a pump off sensitivity, which is stored in memory 111 and set by a user by input device 112, then the stroke is counted as a pump-off stroke and a count of pump-off strokes is increased by one. The pump-off sensitivity may be a percentage less than 100%. The controller 101 may repeat the comparison for each stroke and, if the stroke is not counted as a pump off stroke, the count of pump-off strokes is reset to zero. However, if the count of pump-off strokes reaches a pump-off strokes parameter, the pump-off test fails. The pump-off parameter may be stored in memory 1111 and set by a user by input device 112. The controller 101 may determine that the pump system 100 is pumped off and a pump-off event is detected.

After a pump-off event is detected, the controller 101 may adjust the output speed of the VFD 103 to the min speed set point (1411). The controller 101 may allow the pumping system 100 to run at min speed for two strokes (1412).

The controller 101 may then determine if the fluid recovery test has been passed (1413). The fluid recover test may be the same the pump-off test, except the min speed baseline is used instead of the normal speed baseline. That is, if the stroke average torque is less than the min speed baseline multiplied by the pump off sensitivity, then the test fails. If the test passes for a set number of consecutive strokes, for example five strokes, and a min speed timer has elapsed, which is stored in memory 111 and set by a user by input device 112, the controller 101 control the VFD 103 to a normal speed, wait 2 strokes, and calculate another normal baseline, and start running the pump-off pass test again (1414).

If, however, the fluid recovery test fails, the motor stops (1415) and, after a fluid recover timer elapses, which is stored in memory 111 and set by a user by input device 112, the controller 101 may control the VFD 103 to a min speed, wait 2 strokes, and start running the fluid recovery test again (1416).

While this invention has been particularly shown, and described with reference to exemplary embodiments thereof, it will be understood by those skilled in the art that various changes in form and details may be made therein without departing from the spirit and scope of the invention as defined by the appended claims.

What is claimed is:

1. An apparatus to control a pump system, the apparatus comprising:
at least one memory storing instructions; and
at least one processor that executes the instructions to:
obtain, from a variable frequency drive (VFD), initial motor data of a motor controlled by the VFD;
determine a normal speed baseline of the motor based on the obtained initial motor data;
obtain, from the VFD, current motor data of the motor;
detect a pump-off event of the pump system when the current motor data deviates from the normal speed baseline; and
control the VFD in response to the detected pump off event.

2. The apparatus of claim 1, wherein, to determine the normal speed baseline, the at least one processor further executes the instructions to:
determine a type of the pumping system based on a first portion of the initial motor data; and
determine the normal speed baseline based on the type of the pumping system and a second portion of initial motor data.

3. The apparatus of claim 2, wherein, to determine the type of the pumping system, the at least one processor further executes the instructions to:
obtain, for a set number of cycles, a cycle including a set number of strokes of the motor, cycle motor data based on the first portion of the initial motor data;
determine average torque loads and corresponding times based on the obtained cycle motor data; and
determine whether the pump system is a single peak or a duel peak pump based on the determined average torque loads and corresponding times.

4. The apparatus of claim 3, wherein, to determine the average torque loads and corresponding times, the at least one processor further executes the instructions to:
for each stroke of the set number of strokes of the set number of cycles:
detect when a motor torque rises above a Stroke per Minute (SPM) reference based on the cycle motor data;
sample motor torque from when the motor torque is detected to rise above the SPM reference until motor torque drops below the SPM reference, and obtain a stroke average motor torque and a corresponding time; and
store the stroke average torque value and the corresponding time in the least one memory as torque and time, respectively, for the respective stroke of the respective cycle; and
after the set number of cycles, calculate a X torque, a X time, a Y torque, a Y time, a X1 torque, a X1 time, a Y1 torque, and a Y1 time by averaging stroke average torque values and corresponding times from corresponding strokes across the set number of cycles.

5. The apparatus of claim 4, wherein, to determine whether the pump system is a single peak or a duel peak pump, the at least one processor further executes the instructions to:
determine whether:
X torque is within a set deviation of Y torque,
X time is within a set deviation of Y time,
X1 torque is within a set deviation of Y1 torque, and
X1 time is within a set deviation of Y1 time;
if each are within the respective set deviation, determine that the pump system is a single peak pump; and
if one or more are not within the respective set deviation, determine that the pump system is a duel peak pump.

6. The apparatus of claim 2, wherein, to determine the normal speed baseline, the at least one processor further executes the instructions to:
control the motor to a normal speed;
calculate, for a set number of cycles, a cycle including a set number of strokes of the motor, an average motor torque, an average motor speed, and a maximum motor torque (stroke data points) based on the second portion of the initial motor data and the type of the pumping system, and store the stroke data points in the at least one memory; and
calculate an average of each of the stroke data points across the set number of strokes, and store the average of the stroke data points as the normal speed baseline in the at least one memory.

7. The apparatus of claim 1, wherein, to detect the pump-off event, the at least one processor further executes the instructions to:
calculate, for a stroke of the motor, an immediate motor load based on the current motor data;
detect the pump-off event when the immediate motor load is less than the normal speed baseline by a set percent of the normal speed baseline.

8. The apparatus of claim 1, wherein, to detect the pump-off event, the at least one processor further executes the instructions to:
obtain, for a stroke of the motor, current stroke data of the motor based on the current motor data;
compare, for the stroke of the motor, current stroke data to the normal speed baseline; and
trigger an alarm condition, if the current stroke data is more than an allowed deviation from the normal speed baseline.

9. The apparatus of claim 8, wherein, to compare the current stroke data to the normal speed baseline, the at least one processor further executes the instructions to:
test for a percent deviation in peak torque of the motor;
test for a percent deviation in average torque of the motor; and
test for a percent deviation in average RPM of the motor.

10. The apparatus of claim 9, wherein, to trigger the alarm condition, the at least one processor further executes the instructions to:
trigger the alarm condition if at least one test indicates deviation.

11. An method to control a pump system, the method comprising:
by at least one processor:
obtaining, from a variable frequency drive (VFD), initial motor data of a motor controlled by the VFD;
determining a normal speed baseline of the motor based on the obtained initial motor data;
obtaining, from the VFD, current motor data of the motor;
detecting a pump-off event of the pump system when the current motor data deviates from the normal speed baseline; and
controlling the VFD in response to the detected pump off event.

12. The method of claim 1, wherein, the determining the normal speed baseline includes:
determining a type of the pumping system based on a first portion of the initial motor data; and
determining the normal speed baseline based on the type of the pumping system and a second portion of initial motor data.

13. The method of claim 12, wherein, the determining the type of the pumping system includes:
obtaining, for a set number of cycles, a cycle including a set number of strokes of the motor, cycle motor data based on the first portion of the initial motor data;
determining average torque loads and corresponding times based on the obtained cycle motor data; and
determining whether the pump system is a single peak or a duel peak pump based on the determined average torque loads and corresponding times.

14. The method of claim 13, wherein, the determining the average torque loads and corresponding times includes:
for each stroke of the set number of strokes of the set number of cycles:
detecting when a motor torque rises above a Stroke per Minute (SPM) reference based on the cycle motor data;
sampling motor torque from when the motor torque is detected to rise above the SPM reference until motor torque drops below the SPM reference, and obtaining a stroke average motor torque and a corresponding time; and
storing the stroke average torque value and the corresponding time in at least one memory as torque and time, respectively, for the respective stroke of the respective cycle; and
after the set number of cycles, calculating a X torque, a X time, a Y torque, a Y time, a X1 torque, a X1 time, a Y1 torque, and a Y1 time by averaging stroke average torque values and corresponding times from corresponding strokes across the set number of cycles.

15. The method of claim 14, wherein, the determining whether the pump system is a single peak or a duel peak pump includes:
determining whether:
X torque is within a set deviation of Y torque,
X time is within a set deviation of Y time,
X1 torque is within a set deviation of Y1 torque, and
X1 time is within a set deviation of Y1 time;
if each are within the respective set deviation, determining that the pump system is a single peak pump; and
if one or more are not within the respective set deviation, determining that the pump system is a duel peak pump.

16. The method of claim 12, wherein, the determining the normal speed baseline includes:
controlling the motor to a normal speed;
calculating, for a set number of cycles, a cycle including a set number of strokes of the motor, an average motor torque, an average motor speed, and a maximum motor torque (stroke data points) based on the second portion of the initial motor data and the type of the pumping system, and storing the stroke data points in the at least one memory; and
calculating an average of each of the stroke data points across the set number of strokes, and storing the average of the stroke data points as the normal speed baseline in the at least one memory.

17. The method of claim 11, wherein, the detecting the pump-off event includes:
calculating, for a stroke of the motor, an immediate motor load based on the current motor data; and
detecting the pump-off event when the immediate motor load is less than the normal speed baseline by a set percent of the normal speed baseline.

18. The method of claim 11, wherein, the detecting the pump-off event includes:
obtaining, for a stroke of the motor, current stroke data of the motor based on the current motor data;
comparing, for the stroke of the motor, current stroke data to the normal speed baseline; and
triggering an alarm condition, if the current stroke data is more than an allowed deviation from the normal speed baseline.

19. The apparatus of claim 18, wherein, the comparing the current stroke data to the normal speed baseline includes:
testing for a percent deviation peak torque of the motor;
testing for a percent deviation in average torque of the motor; and
testing for a percent deviation in average RPM of the motor.

20. The apparatus of claim 19, wherein, the triggering the alarm condition includes:
triggering the alarm condition if one or more test indicates deviation.
